(19) United States
(12) Patent Application Publication
(10) Pub. No.: US 2026/0303964 A1
(43) Pub. Date: Oct. 1, 2026

(54) ELECTRONIC DEVICE AND COMMUNICATION SYSTEM

(71) Applicant: Panasonic Intellectual Property Management Co., Ltd., Osaka (JP)

(72) Inventors: Toru TAKASHIMA, Osaka (JP); Shohei KANNO, Osaka (JP); Shinichi YAMAMOTO, Osaka (JP)

(73) Assignee: Panasonic Intellectual Property Management Co., Ltd., Osaka (JP)

(21) Appl. No.: 19/572,950

(22) Filed: Mar. 20, 2026

(30) Foreign Application Priority Data
Mar. 27, 2025 (JP) 2025-053903

(51) Int. Cl. H04N 23/661; H04N 23/663; H04W 72/30

(52) U.S. Cl. CPC H04N 23/662; H04N 23/663; H04W 72/30

(57) ABSTRACT

An electronic device capable of performing data communication with a plurality of imaging apparatuses includes: a communication circuit that performs data communication with each of the plurality of imaging apparatuses; and a controller that generates shooting setting data indicating a setting for image shooting in the plurality of imaging apparatuses. The controller transmits the generated shooting setting data to the plurality of imaging apparatuses via broadcast communication in accordance with a predetermined communication standard to configure the setting for image shooting in the plurality of imaging apparatuses, with a communication connection being unestablished with each of the imaging apparatuses via the communication circuit according to the predetermined communication standard.

### TECHNICAL FIELD

The present disclosure relates to an electronic device capable of performing data communication with a plurality of imaging apparatuses and to a communication system.

### BACKGROUND ART

JP 2024-094652 A discloses a remote control system that performs power-saving near field communication between a remote control apparatus and a controlled target apparatus. This system supplies, to the control target apparatus, a specific control command corresponding to an operation input to the remote control apparatus by using a communication packet of a predetermined format that is exchanged to detect adjacent equipment before connection establishment by pairing between plural pieces of communication equipment. The remote control apparatus generates, by incorporating communication data including the specific control command into the communication packet, a communication connection request including identification information on the remote control apparatus and the communication data. The specific control command may be a control command for ON/OFF of a home appliance such as a television as the control target apparatus, a control command for specifying a broadcasting channel or an input terminal, a control command for controlling output of specific equipment, or the like.

In the control target apparatus, when the identification information included in the communication connection request broadcast from one or more remote control apparatuses matches the identification information of the remote control apparatus stored in advance, the specific control command is supplied based on the received communication data. Each of a plurality of control target apparatuses may save the same identification information of the remote control apparatus, and in this case, ones of the plurality of control target apparatuses can be controlled by operation of the one remote control apparatus.

### SUMMARY

The present disclosure provides an electronic device and a communication system that are capable of facilitating concurrent configuration of a setting for image shooting in a plurality of imaging apparatuses.

In one aspect of the present disclosure, an electronic device capable of performing data communication with a plurality of imaging apparatuses includes a communication circuit and a controller. The communication circuit performs data communication with each of the plurality of imaging apparatuses. The controller generates shooting setting data indicating a setting for image shooting in the plurality of imaging apparatuses. The controller transmits the generated shooting setting data to the plurality of imaging apparatuses via broadcast communication in accordance with a predetermined communication standard, to configure the setting for the image shooting in the plurality of imaging apparatuses, with a communication connection being unestablished with each of the imaging apparatuses via the communication circuit according to the predetermined communication standard.

In one aspect of the present disclosure, a communication system includes a plurality of imaging apparatuses and an electronic device capable of performing data communication with the plurality of imaging apparatuses. The electronic device generates shooting setting data indicating a setting for image shooting in the plurality of imaging apparatuses, and transmits the generated shooting setting data to the plurality of imaging apparatuses via broadcast communication in accordance with a predetermined communication standard, with a communication connection being unestablished with each of the imaging apparatuses according to the predetermined communication standard. Each of the plurality of imaging apparatuses receives the shooting setting data transmitted from the electronic device via the broadcast communication, and changes the setting for the image shooting based on the received shooting setting data.

According to the electronic device and the communication system according to the present disclosure, it is possible to facilitate concurrent configuration of a setting for image shooting in the plurality of imaging apparatuses.

### BRIEF DESCRIPTION OF THE DRAWINGS

FIG. 1 is a diagram illustrating a configuration of a communication system according to a first embodiment of the present disclosure;

FIG. 2 is a diagram illustrating a configuration of a digital camera in the communication system;

FIG. 3 is a diagram illustrating a data structure of advertising data in the communication system;

FIGS. 4A and 4B are diagrams each explaining remote setting information in the communication system;

FIG. 5 is a diagram for explaining sub-tag ID information on a shooting setting for image shooting in the communication system;

FIG. 6 is a sequence diagram illustrating an operation for the shooting setting in the communication system according to the first embodiment;

FIGS. 7A and 7B are diagrams each illustrating a display example of a communication setting screen for the shooting setting of a digital camera;

FIG. 8 is a diagram illustrating advertising data for the shooting setting;

FIG. 9 is a diagram illustrating scan response data for the shooting setting;

FIG. 10 is a diagram illustrating a data structure of advertising data different from that in FIG. 3;

FIG. 11 is a diagram for explaining device ID information in the communication system;

FIGS. 12A, 12B and 12C are diagrams each illustrating a display example of a communication setting screen for a shooting timing setting of the digital camera;

FIG. 13 is a diagram illustrating advertising data for the shooting timing setting;

FIG. 14 is a diagram illustrating scan response data for the shooting timing setting;

FIG. 15 is a diagram illustrating a configuration of a communication system according to a second embodiment;

FIG. 16 is a diagram illustrating a configuration of a control terminal in the communication system according to the second embodiment;

FIG. 17 is a diagram illustrating a data structure of advertising data in the communication system according to the second embodiment;

FIG. 18 is a diagram for explaining device type information in the communication system according to the second embodiment;

FIG. 19A is a sequence diagram illustrating an operation for a video creation setting in the communication system according to the second embodiment;

FIG. 19B is a sequence diagram illustrating an operation subsequent to that in FIG. 19A;

FIGS. 20A, 20B and 20C are diagrams each illustrating a display example of a communication setting screen for the video creation setting in the communication system according to the second embodiment;

FIG. 21 is a diagram illustrating advertising data for the video creation setting;

FIG. 22 is a diagram illustrating scan response data for the video creation setting;

FIGS. 23A and 23B are diagrams each illustrating a display example of an angle setting screen in an electronic device according to a modification of the second embodiment; and

FIG. 24 is a diagram illustrating angle data in a communication system according to the modification of the second embodiment.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art. Note that the inventor(s) provides the accompanying drawings and the following description in order for those skilled in the art to fully understand the present disclosure, and does not intend to limit the subject matter described in the claims by the accompanying drawings and the following description.

### First Embodiment

### 1. Configuration

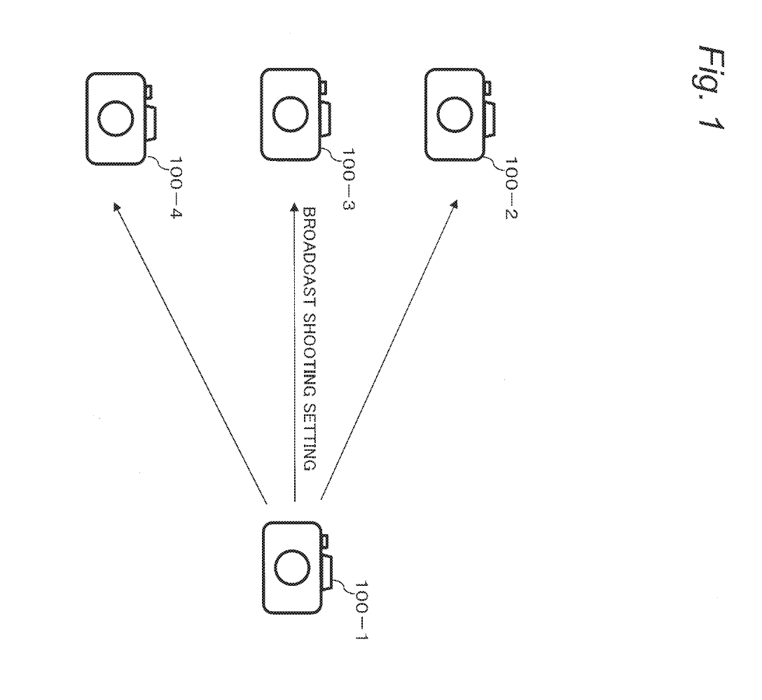

A communication system according to a first embodiment of the present disclosure will be described with reference to FIG. 1.

For example, as illustrated in FIG. 1, the communication system 1 according to the present embodiment includes four digital cameras 100-1 to 100-4. In the present system 1, for example, the digital camera 100-1 is configured to be capable of data communication with each of the digital cameras 100-2 to 100-4 in accordance with a predetermined communication standard. In the present system 1, data communication is performed according to a Bluetooth (registered trademark) Low Energy (BLE) standard as the predetermined communication standard. Hereinafter, each of the digital cameras 100-1 to 100-4 is also collectively referred to as a digital camera 100.

In the BLE standard, at the start of a communication connection, an advertisement packet for detecting a surrounding device is transmitted from a peripheral device that requests the connection, and the communication connection is established according to a response from a central device requested for the connection. The present system 1 transmits data from the digital camera 100-1 to the digital cameras 100-2 to 100-4 using an advertisement packet broadcast before establishing the communication connection according to the BLE standard. In the present system 1, shooting setting data indicating a setting for image shooting, such as various shooting settings, in the digital camera 100 is transmitted.

The present system 1 can be used to configure a setting for image shooting in the other digital cameras 100-2 to 100-4 by the digital camera 100-1 transmitting the shooting setting data. Such transmission enables the present system 1 to share the shooting setting among the plurality of digital cameras 100, for example. Although FIG. 1 illustrates the communication system 1 including the four digital cameras 100, the present system 1 may include, for example, three or five or more digital cameras 100.

### 1-1. Configuration of Digital Camera

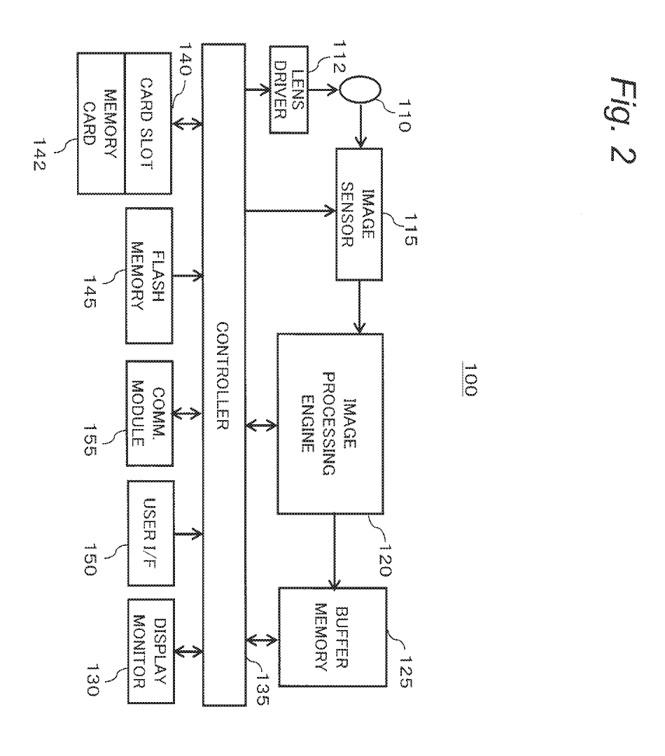

A configuration of each of the digital cameras 100 according to the present embodiment will be described with reference to FIG. 2.

FIG. 2 is a diagram illustrating a configuration of the digital camera 100 in the present system 1. The digital camera 100 is an example of an imaging apparatus according to the present embodiment or is an example of an electronic device such as various computers including an image sensor. The digital camera 100 according to the present embodiment includes an image sensor 115, an image processing engine 120, a display monitor 130, and a controller 135. The digital camera 100 further includes a buffer memory 125, a card slot 140, a flash memory 145, a user interface 150, and a communication module 155. The digital camera 100 further includes, for example, an optical system 110 and a lens driver 112.

The optical system 110 includes a focus lens, a zoom lens, an optical image stabilization (OIS) lens, a diaphragm, a shutter, and the like. The focus lens is a lens for changing a focus state of a subject image formed on the image sensor 115. The zoom lens is a lens for changing magnification of a subject image formed by the optical system. Each of the focus lens and other lenses includes one lens or a plurality of lenses.

The lens driver 112 drives the focus lens and the like in the optical system 110. The lens driver 112 includes a motor, and moves the focus lens along the optical axis of the optical system 110 under control by the controller 135. A configuration for driving the focus lens in the lens driver 112 can be implemented by a DC motor, a stepping motor, a servo motor, an ultrasonic motor, or the like.

The image sensor 115 captures a subject image formed via the optical system 110 and generates imaging data. The imaging data constitutes image data indicating an image captured by the image sensor 115. The image sensor 115 generates image data of a new frame at a predetermined frame rate (e.g., 30 frames per second). The timing of generating the imaging data and an electronic shutter operation in the image sensor 115 are controlled by the controller 135. As the image sensor 115, various image sensors such as a CMOS image sensor, a CCD image sensor, and an NMOS image sensor can be used.

The image sensor 115 performs an operation of capturing a still image, an operation of capturing a through image, and the like. The through image is mainly a moving image, and is displayed on the display monitor 130 for a user to determine a composition for capturing a still image. Each of the through image and the still image is an example of a captured image in the present embodiment.

The image processing engine 120 performs various types of processing on imaging data output from the image sensor 115 to generate image data, and performs various types of processing on the image data to generate an image to be displayed on the display monitor 130. Examples of the various types of processing include, but are not limited to, white balance correction, gamma correction, YC conversion processing, electronic zoom processing, compression processing, expansion processing, and the like. The image processing engine 120 may be constituted by a hard-wired electronic circuit, or may be constituted by a microcomputer, a processor, or the like that uses a program.

The display monitor 130 is an example of a display that displays various types of information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be constituted by, for example, a liquid crystal display device or an organic EL device.

The user interface 150 is a general term for various user interfaces such as hard keys including an operation button and an operation lever provided on an exterior of the digital camera 100, and software keys. The user interface 150 is configured to receive an operation by the user. The user interface 150 includes, for example, a release button, a mode dial, and a touch panel. When receiving the operation by the user, the user interface 150 transmits an operation signal corresponding to such a user operation to the controller 135.

The controller 135 comprehensively controls the overall operation of the digital camera 100. The controller 135 includes a CPU and the like, and the CPU executes a program (software) to implement a predetermined function. The controller 135 may include, instead of the CPU, a processor including a dedicated electronic circuit designed to implement the predetermined function. That is, the controller 135 can be implemented by various processors such as a CPU, an MPU, a GPU, a DSP, an FPGA, and an ASIC. The controller 135 may include one or more processors. In addition, the controller 135 and the image processing engine 120 (or the like) may be implemented on one semiconductor chip.

The buffer memory 125 is a recording medium that functions as a work memory for the image processing engine 120 and the controller 135. The buffer memory 125 is implemented by a dynamic random access memory (DRAM) or the like. The flash memory 145 is a nonvolatile recording medium. Although not illustrated, the controller 135 may include various internal memories, for example, may include a ROM. The ROM stores various programs to be executed by the controller 135. Such programs may be stored in the flash memory 145 as an example of a tangible non-transitory computer readable recording medium. In addition, the controller 135 may incorporate a RAM that functions as a work area of the CPU.

The card slot 140 is an interface into which a detachable memory card 142 is inserted. The card slot 140 can electrically and mechanically connect the memory card 142. The memory card 142 is an external memory including a recording element such as a flash memory therein. The memory card 142 can store data such as image data generated by the image processing engine 120.

The communication module 155 is a module (circuit) that is connected to an external device in accordance with a predetermined communication standard in wired or wireless communication. Examples of the predetermined communication standard include, for example, ZigBee (registered trademark), IEEE802.11, Wi-Fi (registered trademark), and the like in addition to Bluetooth. Further, the communication module 155 may be connected to an external device in accordance with the USB and/or HDMI (registered trademark) standards. The digital camera 100 can communicate with another device via the communication module 155. The communication module 155 is an example of a communication circuit in the imaging apparatus or the electronic device according to the present embodiment.

### 1-2. Data and Information on Advertisement Packet

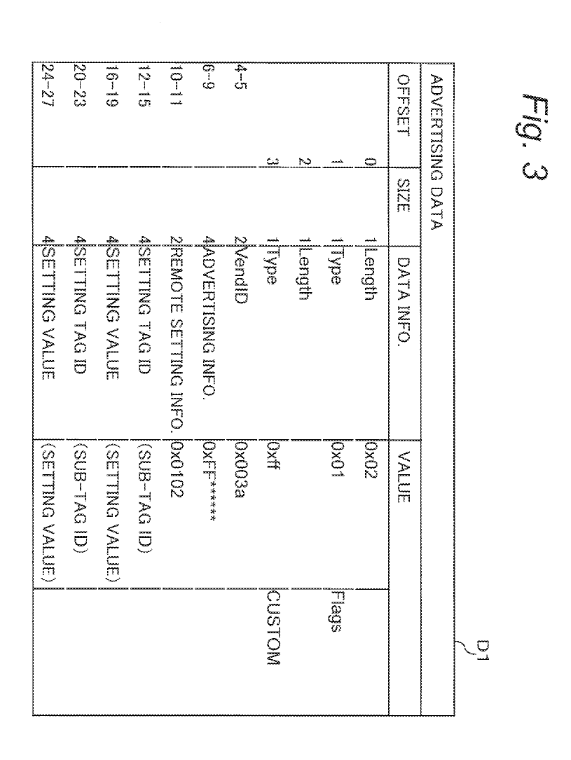

Data constituting the advertisement packet and relevant information in the present system 1 will be described with reference to FIGS. 3 to 5.

The advertisement packet according to the BLE standard includes advertising data in which various data is stored, following a preamble such as predetermined identification information, an access address, a header, and an advertiser address. FIG. 3 is a diagram illustrating a data structure of advertising data D1 in the present system 1. The advertising data D1 stores values for a plurality of data items, each of which is stored in a predetermined size based on the number of bytes according to a storage position indicating an offset position from the head. For example, as illustrated in FIG. 3, “Length” indicating a data length and “Type” indicating a predetermined data type are repeatedly designated from the head of the advertising data D1 according to the stored data.

In the advertising data D1 illustrated in FIG. 3, a value in “Flags” indicating control information in a communication connection according to the BLE standard is designated as the first Type, and a corresponding data length is designated. In the next Type, a value indicating any transmission data is designated as “Custom” in FIG. 3, and a data length is designated in “Length”.

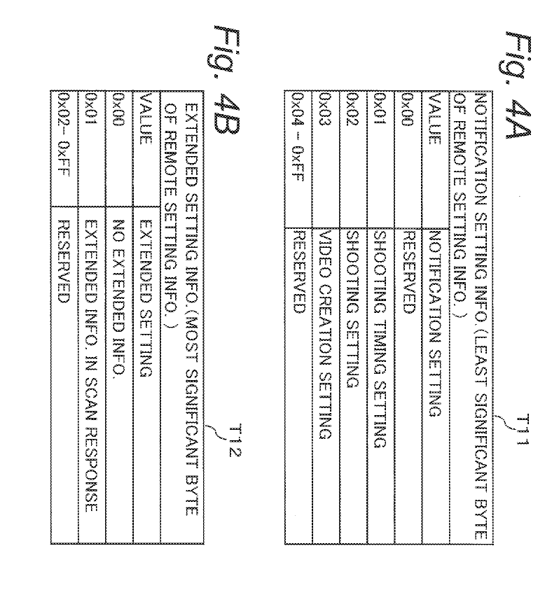

Further, the advertising data D1 stores values of respective data items, for example, “VendID” for identifying a manufacturer of each digital camera 100, advertisement information indicating information unique to each digital camera 100, and remote setting information indicating a configuration of data to be communicated. FIGS. 4A and 4B are diagrams each explaining the remote setting information in the present system 1. The remote setting information in the present system 1 has a size of two bytes, and indicates two types of settings by respective values of the lower 1 byte and the upper 1 byte (i.e., the least significant byte and the most significant byte).

FIG. 4A illustrates notification setting information T11 corresponding to the lower 1 byte of the remote setting information. In the notification setting information T11, a value of the lower 1 byte is associated with a setting for image shooting notified from a sender (i.e., an advertiser) to a receiver (i.e., a scanner) of the advertising data D1 in the present system 1. The notification setting information T11 is used to manage, each as such a notification setting, three types of settings; an “shooting timing setting” for a timing of image shooting in the digital camera 100, an “shooting setting” for an image to be shot, and a “video creation setting” for video shooting such as shooting a moving image for creating a video work.

In the advertising data D1 illustrated in FIG. 3, the lower 1 byte of the remote setting information is set to a value indicating the shooting setting, and two pairs of a setting tag ID and a setting value, the setting tag ID designating the shooting setting to be notified, and the setting value indicating a value set for the designated shooting setting. The setting tag IDs are designated by, for example, values of the sub-tag IDs defined for setting items of the shooting settings.

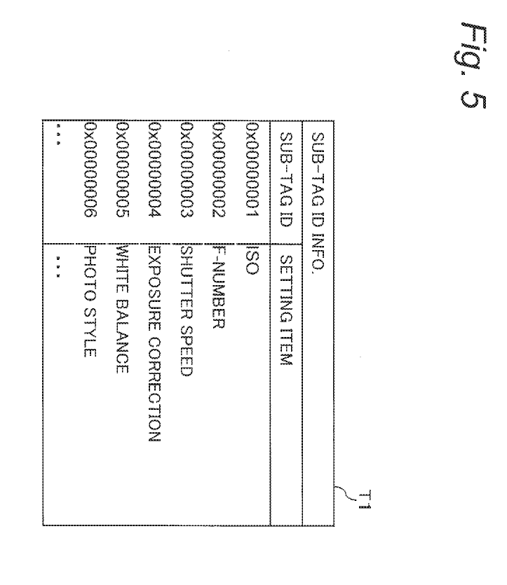

FIG. 5 is a diagram for explaining sub-tag ID information T1 on the shooting setting in the present system 1. The sub-tag ID information T1 is used to manage a plurality of sub-tag IDs each associated with a setting item for the shooting setting indicated by each sub-tag ID. The setting item includes, for example, a photo style in addition to ISO indicating ISO sensitivity, a F-number indicating an aperture value, a shutter speed, exposure correction, and white balance according to a state set for the image shooting of the digital camera 100.

For example, the photo style is provided corresponding to each of a plurality of shooting modes prepared in advance so that the digital camera 100 can easily shoot an image with a color tone and image quality intended by the user. The photo style is configured as, for example, a parameter set for adjusting an image indicated by raw data output from the image sensor 115 before image processing.

Returning to FIGS. 4A and 4B, FIG. 4B illustrates extended setting information T12 corresponding to the upper 1 byte of the remote setting information. The extended setting information T12 associates a value of the upper 1 byte with an extended setting indicating whether information to be transmitted in addition to the advertising packet. When scanning a connection destination according to the BLE standard, the central device may further request the peripheral device to provide additional information after transmitting the advertising packet, and receive the additional information from the peripheral device responding to such a scan request. In the present system 1, it is possible to configure the extended setting as to whether to transmit additional data using such a scan response to the scan request.

For example, as the extended setting in the advertising data D1, whether additional data is subsequently transmitted is managed by presence or absence of the extended information as illustrated in FIG. 4B. In the remote setting information illustrated in FIG. 3, the upper 1 byte is set to a value indicating that “extended information is present in the scan response”.

For example, the sub-tag ID information T1, the notification setting information T11, and the extended setting information T12 may be stored in advance in the flash memory 145 of each of the digital cameras 100, or may be acquired from outside of the digital camera 100 via a communication network connected by the communication module 155. The information stored in the memory card 142 is not limited to being acquired via the communication module 155 and may be acquired via the card slot 140.

### 2. Operation

The operation of the present system 1 configured as described above will be described below.

In the communication system 1 according to the present embodiment as illustrated in FIG. 1, each of the digital cameras 100 performs data communication conforming to the BLE standard. For example, the digital camera 100-1, functioning as the peripheral device according to the BLE standard, broadcasts the advertising packet to transmit the shooting setting data to the digital cameras 100-2 to 100-4, which functioning as central devices. The digital camera 100-1 of the present system 1 collectively sets various shooting settings for the digital cameras 100-2 to 100-4 by transmitting the above-described advertising data D1 and the like as the shooting setting data.

For example, in a situation such as an image shooting lecture in which the plurality of digital cameras 100 are used, it would be demanded to share, from the digital camera 100-1 of a lecturer, the shooting setting of the digital camera 100-1 to the digital cameras 100-2 to 100-4 of respective participants. Generally, in data communication according to the BLE standard, the central device performs one-to-one communication with each of a plurality of peripheral devices after establishing a communication connection with each of the plurality of peripheral devices. In this case, for example, it is necessary to individually establish the communication connection with each peripheral device from one central device to configure a setting in each peripheral device and/or perform an operation of each peripheral device.

On the other hand, according to the present system 1, the digital camera 100-1 generates and broadcasts the shooting setting data, so that each of the digital cameras 100-2 to 100-4 can change the shooting setting in each digital camera 100 based on the received shooting setting data. As described above, in the present system 1, the shooting setting can be easily configured concurrently in the plurality of digital cameras 100 with an individual communication connection among the digital cameras 100 being unestablished.

### 2-1. Shooting Setting

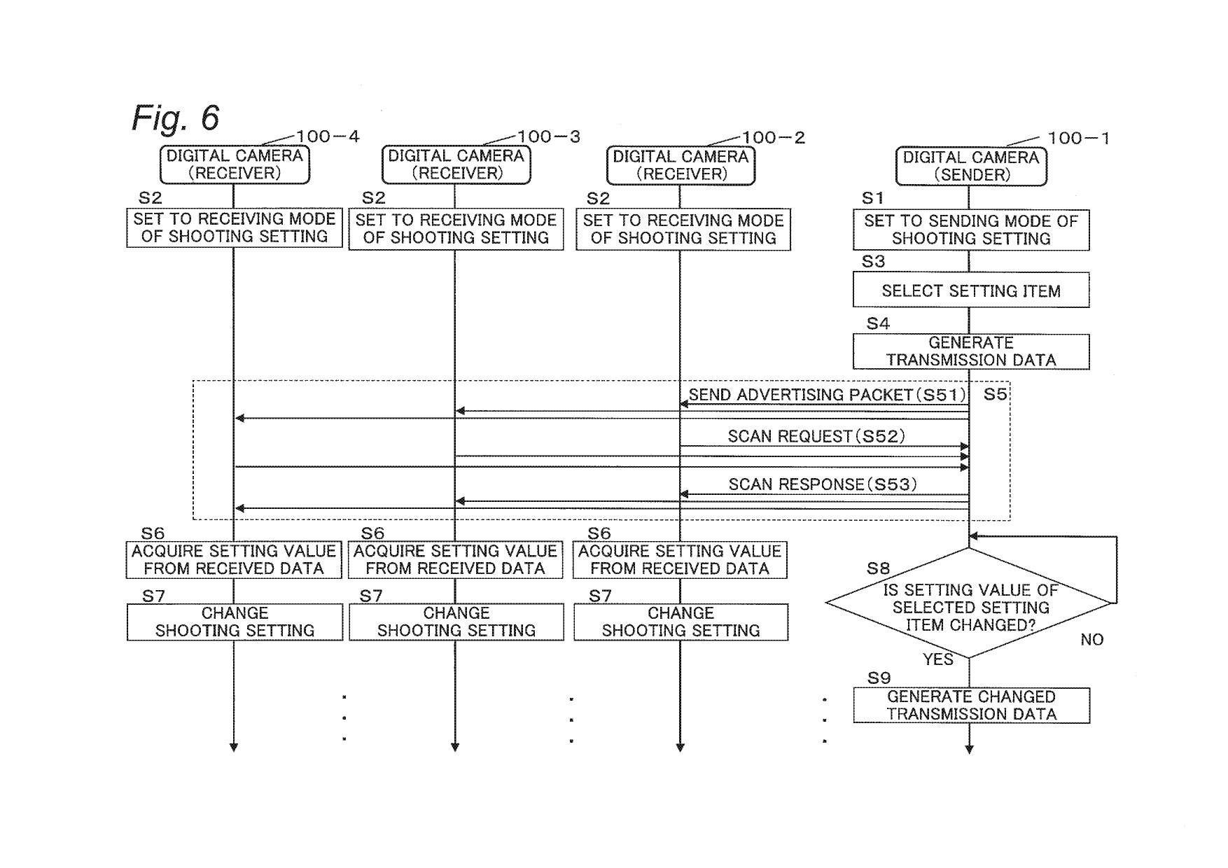

An operation for the shooting setting in the present system 1 as described above will be described with reference to FIGS. 6 to 9.

FIG. 6 is a sequence diagram illustrating the operation for the shooting setting in the communication system 1 according to the present embodiment. The operation example illustrated in FIG. 6 is started in a state where the shooting setting for the image shooting by the image sensor 115 is set in the digital camera 100-1 and the setting value of the setting item is stored in the buffer memory 125. Each processing in the present operation example is executed by the controller 135 of each of the digital cameras 100.

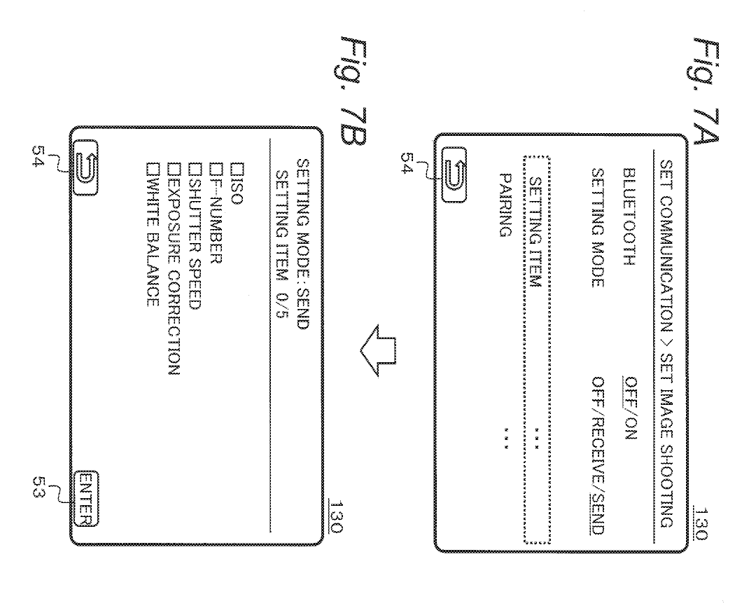

For example, each of the digital cameras 100 according to the present embodiment has, as operation modes for the shooting setting, not only a setting mode to send or receive the shooting setting by performing data communication with the other digital cameras 100 but also a setting mode to disable the sending and receiving. For example, the digital camera 100 displays, on the display monitor 130, a communication setting screen for configuring a setting for data communication for the shooting setting in response to a predetermined user operation. FIGS. 7A and 7B are diagrams each illustrating a display example of the communication setting screen for the shooting setting of the digital camera 100.

For example, the communication setting screen illustrated in FIG. 7A includes options for switching a disable or enable state of a Bluetooth function by selecting “OFF” or “ON” and options for the above-described setting modes. The Bluetooth function and the setting modes are disabled, that is, set to “OFF” in an initial state, for example. In the operation example illustrated in FIG. 6, the controller 135 of the digital camera 100-1 sets the setting mode of the digital camera 100-1 to a sending mode for sending the shooting setting in response to a user operation input via the user interface 150 on the communication setting screen (S1). FIG. 7A illustrates an example in which the sending mode is selected from the options for the setting modes, and options for the user to select a setting item in the shooting setting is displayed.

The communication setting screen illustrated in FIG. 7A includes an option of a pairing registration for registering and managing a device for which a communication connection according to the Bluetooth function is authenticated, and a return button 54. The return button 54 receives a user operation to return screen transition of the digital camera 100 by one screen.

In response to a user operation received via the user interface 150, the controller 135 of each of the digital cameras 100-2 to 100-4 configures the setting mode of each of the digital cameras 100-2 to 100-4 to a receiving mode for receiving the shooting setting (S2). For example, as in FIG. 7A, each of the digital cameras 100-2 to 100-4 displays the communication setting screen including the options for the Bluetooth function and the setting modes on the display monitor 130, and receives the user operation. In step S2, for example, when the receiving mode is selected in response to the user operation and ON is selected for the Bluetooth function, each of the digital cameras 100-2 to 100-4 transitions to a state where the digital camera is allowed to receive the advertising packet via the communication module 155.

In the digital camera 100-1 set to the sending mode, the controller 135 receives, via the user interface 150, a user operation selecting the setting item for the shooting setting (S3). The controller 135 causes the communication setting screen to transition to a selection screen illustrated in FIG. 7B in response to a user operation selecting an option of “setting item” illustrated in FIG. 7A, for example. The selection screen illustrated in FIG. 7B includes an enter button 53 and the return button 54 in addition to options for the ISO, F-number, shutter speed, exposure correction, and white balance as the setting item. For example, the enter button 53 receives a user operation determining an option selected in the digital camera 100.

For example, after determining the setting item selected in step S3, the controller 135 of the digital camera 100-1 generates the transmission data such as the advertising data D1 to be transmitted to the other digital cameras 100 (S4). For example, after returning to the screen illustrated in FIG. 7A in response to a user operation of pressing the enter button 53 illustrated in FIG. 7B, the controller 135 generates the transmission data in response to a user operation of enabling the Bluetooth function. The controller 135 further generates scan response data to be transmitted as the transmission data in response to the extended setting in the remote setting information as illustrated in FIG. 4B, for example.

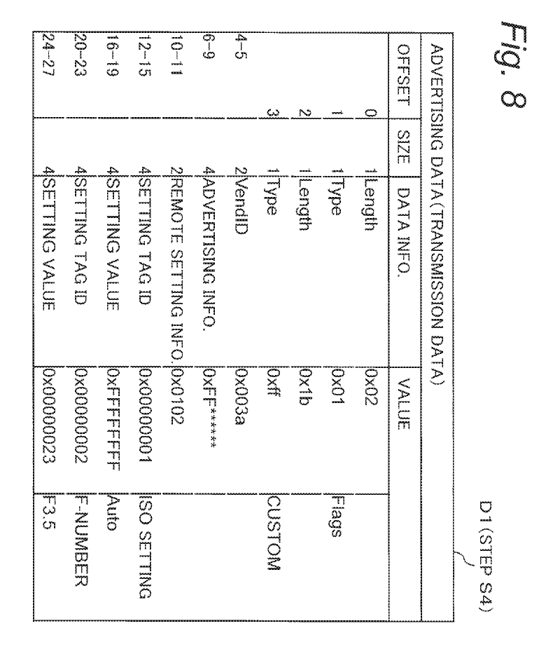

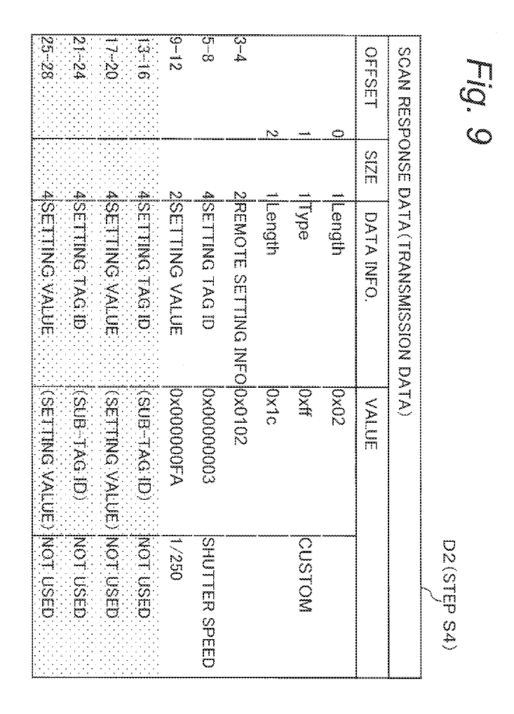

FIGS. 8 and 9 illustrate the transmission data generated in step S4 in a case where the ISO, F-number, and shutter speed are selected and determined as the setting items in step S3. FIG. 8 is a diagram illustrating the advertising data D1 for the shooting setting. FIG. 9 is a diagram illustrating scan response data D2 for the shooting setting.

The advertising data D1 illustrated in FIG. 8 stores, as a value of the setting tag ID in the data structure illustrated in FIG. 3, a value of the sub-tag ID indicating each of the ISO and F-number in the sub-tag ID information T1 illustrated in FIG. 5. In the example illustrated in FIG. 8, a value indicating “Auto” that is an operation mode in which the digital camera 100 automatically determines the ISO is stored in a setting value of the ISO, and a value indicating “F3.5” is stored in a setting value of the F-number.

For example, as illustrated in FIG. 9, the scan response data D2 has a data structure capable of storing the setting tag ID and a corresponding setting value instead of “VendID” and “advertisement information” of the advertising data D1. In the scan response data D2 illustrated in FIG. 9, a value of the sub-tag ID indicating the shutter speed is stored as a value of the setting tag ID, and a value indicating “1/250” is stored as a corresponding setting value. In step S4, the controller 135 generates the transmission data D1 and D2 based on the setting values stored in the buffer memory 125, for example.

The controller 135 of the digital camera 100-1 broadcasts the generated transmission data D1 and D2 to the digital cameras 100-2 to 100-4 via the communication module 155 (S5). In step S5, first, the controller 135 transmits the advertising data D1 in the advertisement packet (S51). The controller 135 receives the scan request transmitted from the digital cameras 100-2 to 100-4 that respond to receiving the advertisement packet (S52), and further transmits the scan response data D2 in the scan response (S53).

In each of the digital cameras 100-2 to 100-4, the controller 135 receives the advertising data D1 and the scan response data D2 via the communication module 155, and acquires the setting value for each setting item from the received data (S6). The controller 135 acquires the setting value stored for the setting item indicated by the sub-tag ID from the received data D1 and D2, referring to the notification setting information T11 and the extended setting information T12 illustrated in FIG. 4 in addition to the sub-tag ID information T1 illustrated in FIG. 5, for example.

In each of the digital cameras 100-2 to 100-4, the controller 135 changes the shooting setting based on the acquired setting value (S7). Each of the digital cameras 100-2 to 100-4 may notify the user of the change in the setting, by performing a predetermined operation according to the change in the shooting setting, for example. The predetermined operation may be blinking of an LED or the like provided on the exterior to emit auxiliary light for autofocus (AF) control.

As described above, in the present system 1, the digital camera 100-1 broadcasts the scan response data D2 according to the advertising data D1 and the extended setting (S5), thereby configuring the shooting setting on the digital cameras 100-2 to 100-4.

In the digital camera 100-1 according to the present embodiment, for example, after the transmission data is broadcast (S5), the controller 135 further determines whether the setting value of the selected setting item is changed (S8). When the setting value is not changed (NO in S8), the controller 135 repeats the determination in step S8. For example, in a case where a user operation to change the shooting setting is input via the user interface 150, the controller 135 determines that the setting value is changed (YES in S8), and generates the transmission data in which the changed setting value is stored (S9) as in step S4. Thereafter, the present system 1 repeats processing similar to that after step S5.

For example, when the setting value of ISO is changed from “Auto” to “200” in the digital camera 100-1 (YES in S8), the transmission data such as the advertising data D1 storing the changed setting value is generated (S9) and broadcast (S5). For example, the digital cameras 100-2 to 100-4 may detect the advertisement packet at a predetermined cycle, or may receive a changed advertising packet in response to a predetermined user operation. Further, for example, in a case where the setting item is selected and determined again as in step S3, processing similar to that after step S4 may be repeated.

Each of the digital cameras 100 stops sending and receiving the advertising packet or the like in response to a user operation of disabling the Bluetooth function on the communication setting screen (see FIG. 7A), and ends the processing in the operation example illustrated in FIG. 6, for example.

According to the operation for the shooting setting as described above, in the present system 1, the digital camera 100-1 generates and broadcasts the transmission data D1 and D2 for the setting item (S4 and S5), thereby configuring the shooting setting in the digital cameras 100-2 to 100-4 (S6 and S7). As described above, the present system 1 can configure the shooting setting in the plurality of digital cameras 100-2 to 100-4 from the digital camera 100-1 by broadcasting the advertising packet and the like in accordance with the BLE standard without establishing a communication connection according to the BLE standard.

Further, according to the advertising data D1 and the scan response data D2 broadcast in the present system 1, a plurality of setting items for the shooting setting, such as the ISO and F-number, can be set in the digital cameras 100-2 to 100-4 concurrently. As described above, in the present system 1, it is possible to easily configure the shooting setting in the plurality of digital cameras 100 concurrently.

In the above example, in the digital camera 100, sending and receiving the advertising packet or the like is ended in response to the user operation of disabling the Bluetooth function. The digital camera 100 may stop the sending and receiving in response to a user operation different from that described in the example, or may automatically stop the sending and receiving. For example, the digital cameras 100-2 to 100-4 may stop subsequent receiving in response to completion of the previous receiving or after elapse of a predetermined period from the previous receiving. Further, in the above-described example, the Bluetooth function is disabled after performing the shooting setting. However, for example, a communication connection may be established between the digital camera 100-1 and each of the digital cameras 100-2 to 100-4 according to the BLE standard after performing the shooting setting.

In addition, although FIG. 7B illustrates shooting settings selected as the setting items, the setting item is not limited to the above-described example. For example, the digital camera 100 may receive a user operation of changing an option for the setting item and change the shooting setting to be selected. Further, the sub-tag ID information T1 is not limited to the above-described example, and may include one or more of the setting items illustrated in FIG. 5, or may include other setting items, for example. Further, the order in which steps S1 to S4 are executed is not limited to the above-described example. For example, before the processing of broadcasting the transmission data (S5), each of the digital cameras 100-2 to 100-4 may be set to the receiving mode as in step S2.

In step S4 described above, the example is described in which the transmission data is generated in response to the user operation of enabling the Bluetooth function. The generation of the transmission data is not limited to the above-described example, and may be performed in response to a predetermined user operation received via the user interface 150, for example. In this case, for example, in step S1, the Bluetooth function may be enabled, that is, set to ON. Further, in step S4 described above, the example in which the advertising data D1 and the scan response data D2 are generated as the transmission data is described, but the transmission data may be only the advertising data D1. For example, the extended setting information in the remote setting information of the advertising data D1 may be changed according to the number of setting items selected in step S2.

### 2-2. Shooting Timing Setting

In the above description, the example is described in which the digital camera 100-1 sets the shooting setting common to the digital cameras 100-2 to 100-4 as the setting for the image shooting. The present system 1 is not limited to the above-described example, and for example, the digital camera 100-1 may set a timing at which each of the digital cameras 100-2 to 100-4 performs image shooting.

For example, the user may need to shoot images of a subject from various angles using the plurality of digital cameras 100 at the same time. According to the communication system 1 in the present example, the plurality of digital cameras 100 can be easily set concurrently so that each of the digital cameras 100 performs image shooting at a desired timing. Such shooting timing setting in the present system 1 will be described below.

### 2-2-1. Advertising data and Device IDs

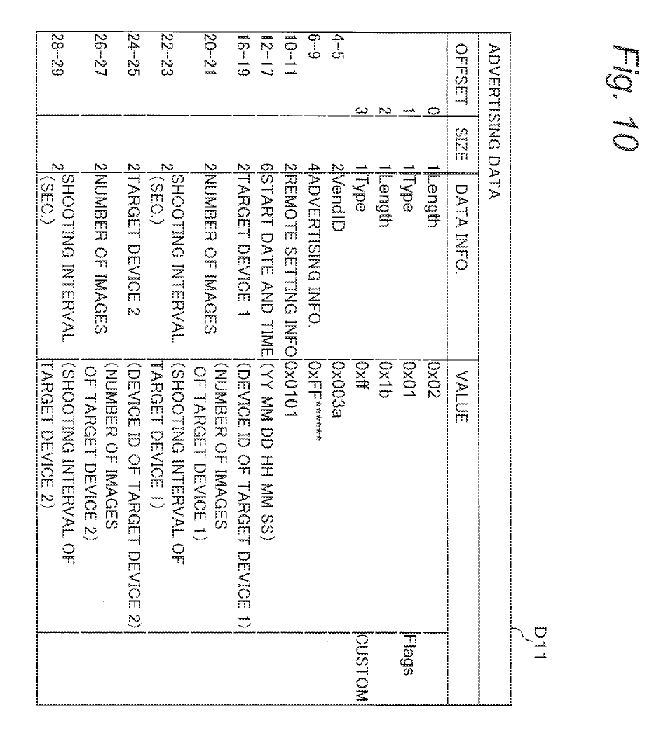

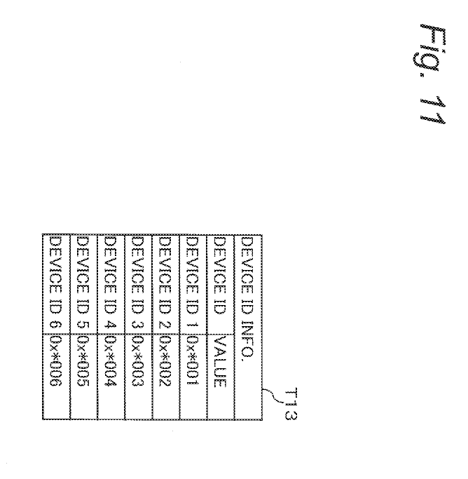

The communication system 1 in the present example configures the shooting timing setting in each of the digital cameras 100 by including IDs to identify the digital cameras 100-2 to 100-4 as transmission destinations in the transmission data to be broadcast from the digital camera 100-1. Advertising data including such device IDs and information indicating the device IDs will be described with reference to FIGS. 10 and 11.

FIG. 10 is a diagram illustrating a data structure of advertising data D11 different from that illustrated in FIG. 3. In the advertising data D11, the remote setting information is changed, from the advertising data D1 (FIG. 3) for the shooting setting, to a value indicating the shooting timing setting illustrated in the notification setting information T11 (FIG. 4A).

Further, in the advertising data D11, instead of the setting tag IDs and the setting values in the advertising data D1, as the shooting timing, in addition to a start date and time of the image shooting, the number of images to be shot and a shooting interval are stored for each target device for which the shooting timings are set. The target device is, for example, a device such as the digital camera 100 identified by the device ID as a transmission destination of the advertising data D11 in the communication system 1. In the present example, each of the number of images to be shot and the shooting interval is set to a value of 2 bytes, and for example, the shooting interval can be set to a maximum of 65535 seconds.

FIG. 11 is a diagram for explaining device ID information T13 in the present system 1. The device ID information T13 is used to manage a value corresponding to each device ID for a plurality of device IDs, for example. For example, the device ID information T13 illustrated in FIG. 11 includes six device IDs according to the maximum number of setting values for each target device that can be stored in the advertising data D11 and the scan response data. For example, the device ID information T13 may be stored in advance in the flash memory 145 of each of the digital cameras 100, or may be acquired from outside of the digital cameras 100.

In the value of each device ID, upper 4 bits indicated as “*” in FIG. 11 indicate a type of target device such as an image shooting device including the digital camera 100. Details of such a device type will be described later.

### 2-2-2. Operation Example

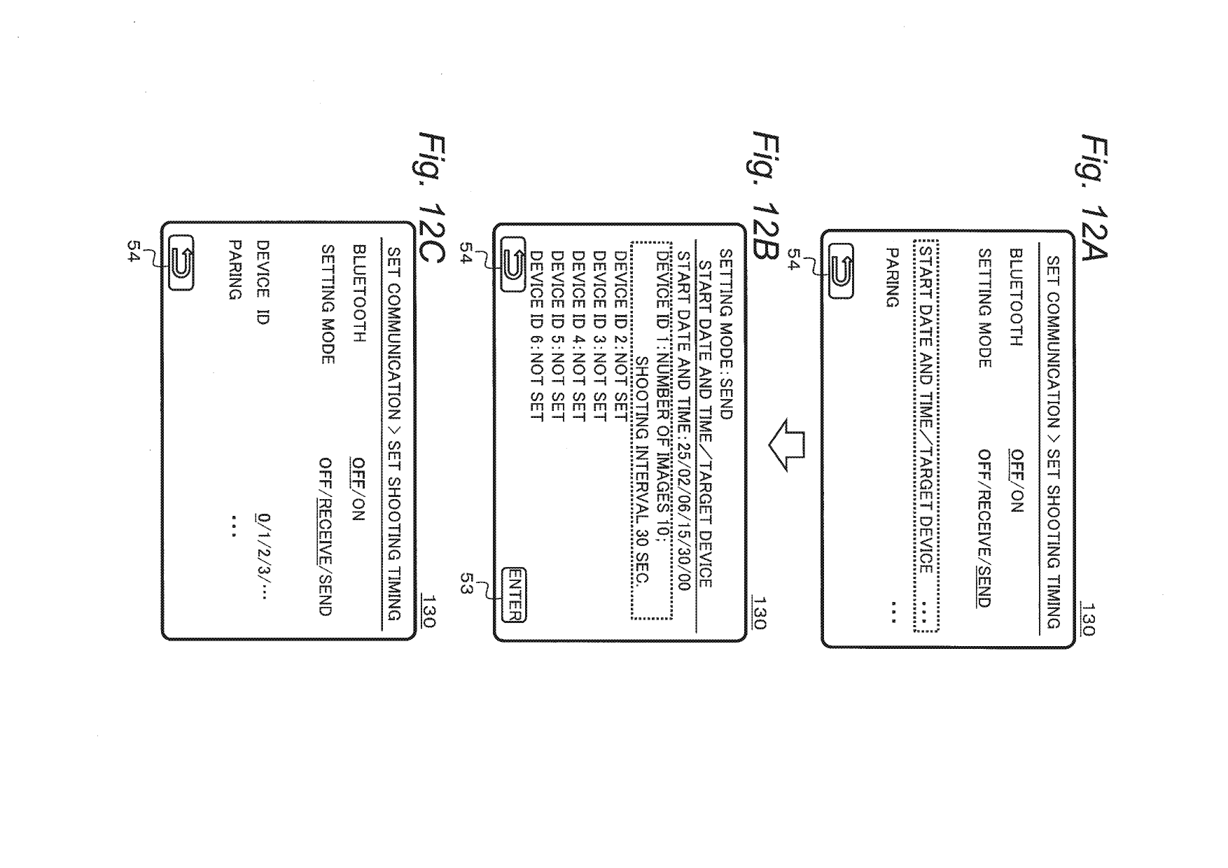

In the present system 1, an operation for the shooting timing setting uses the advertising data D11 including the device IDs as described above. Such an operation will be described with reference to FIGS. 12 to 14.

In the present example, the digital camera 100 displays a communication setting screen to set data communication for the shooting timing setting in response to a predetermined user operation. FIGS. 12A and 12B are diagrams each illustrating a display example of the communication setting screen for the shooting timing setting of the digital camera 100. For example, as in steps S1 and S2 in FIG. 6, in response to the user operation of selecting the setting mode on the communication setting screen, the digital camera 100-1 is set to the sending mode for the shooting timing setting, and the digital cameras 100-2 to 100-4 are set to the receiving mode.

FIG. 12A illustrates an example in which the sending mode is selected similarly to the display example (FIG. 7A) of the communication setting screen for the shooting setting, and an option of “shooting start date and time/target device setting” in the shooting timing setting is displayed instead of the “setting item” illustrated in FIG. 7A. For example, instead of step S3 in FIG. 6, the controller 135 in the digital camera 100-1 in the sending mode receives, via the user interface 150, a user operation of setting the start date and time of image shooting and the target device for the shooting timing setting. For example, the controller 135 causes the communication setting screen to transition to a setting screen for such a shooting start date and time and the like in response to a user operation of selecting the option “shooting start date and time/target device setting” illustrated in FIG. 12A. FIG. 12B illustrates a display example after the transition.

For example, on the setting screen illustrated in FIG. 12B, the controller 135 receives, via the user interface 150, a user operation of setting the number of images to be shot and the shooting interval for each device ID, in addition to the shooting start date and time. For example, the target device for the shooting timing setting is set to the digital camera 100 corresponding to the device ID for which the number of images to be shot and the shooting interval are set. In the example illustrated in FIG. 12B, the target device with a “device ID 1” is set so as to perform, from the shooting start date and time, the image shooting every 30 seconds of the shooting interval, to repeat the image shooting 10 times corresponding to the set number of images to be shot.

Further, in the present example, each of the digital cameras 100-2 to 100-4 set to the receiving mode displays an option for the device ID on the communication setting screen as illustrated in FIG. 12C, and receives a user operation of setting the device ID of the digital camera. The device ID may be displayed as a value (e.g., “0” in FIG. 12C) indicating an unset state in the initial state. Setting the device ID can be performed in response to setting of each of the digital cameras 100 to the receiving mode of the shooting timing, for example.

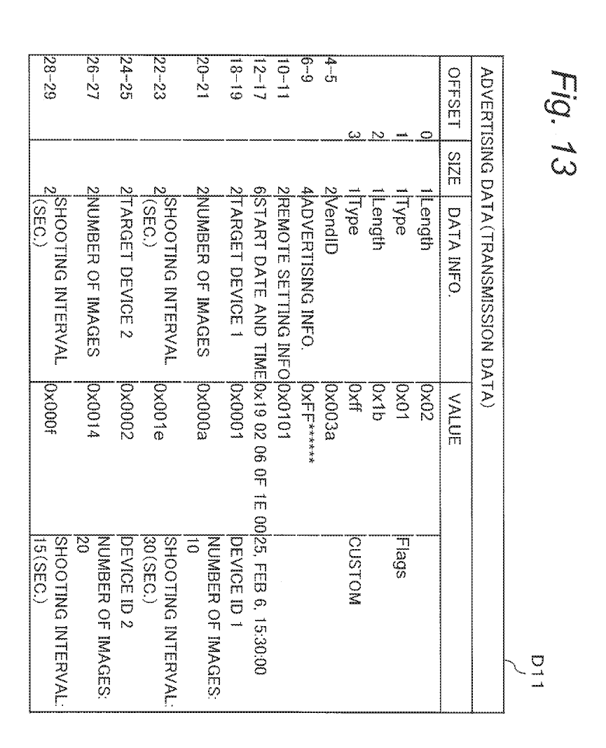

The controller 135 of the digital camera 100-1 determines the shooting timing in response to a user operation on the enter button 53 on the setting screen illustrated in FIG. 12B, for example, and then generates the transmission data such as the advertising data D11 (S4). FIG. 13 illustrates the advertising data D11 generated as the transmission data in the shooting timing setting. In the example illustrated in FIG. 13, in addition to the shooting start date and time and setting values for a target device 1 as illustrated in FIG. 12B, setting values of the device ID, the number of images to be shot, and the shooting interval for a target device 2 are further stored.

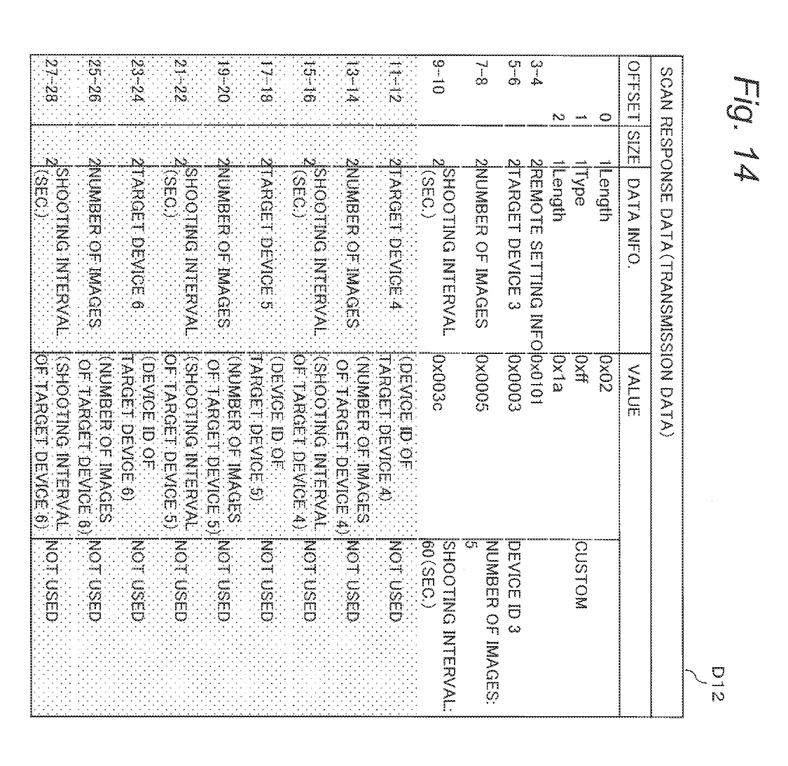

Further, in the present example, the scan response data is further generated as the transmission data according to the extended setting (see FIG. 4B) in the remote setting information of the advertising data D11 (S4). FIG. 14 is a diagram illustrating scan response data D12 for the shooting timing setting. The scan response data D12 stores setting values of the device ID, the number of images to be shot, and the shooting interval for each target device, for example, instead of the setting tag ID and the corresponding setting value of the scan response data D2 (FIG. 9) for the shooting setting. In the example illustrated in FIG. 14, setting values for a target device 3 set subsequently to the target devices 1 and 2 illustrated in FIG. 13 are stored.

Similarly to steps S51 to S53 in FIG. 6, the controller 135 of the digital camera 100-1 broadcasts the generated transmission data D11 and D12 (S5). In the present example, the controller 135 of each of the digital cameras 100-2 to 100-4 receiving the broadcast data acquires a setting value corresponding to the digital camera from the received data D11 and D12 by referring to the device ID. In each of the digital cameras 100-2 to 100-4, the controller 135 sets the shooting timing based on the acquired setting value.

According to the operation of the present system 1 as described above, the digital camera 100-1 broadcasts the transmission data D11 and D12 to set the shooting timing in the digital cameras 100-2 to 100-4. In the present system 1, for example, the shooting timing can be set for each of the digital cameras 100-2 to 100-4 based on the device ID (see FIGS. 10 to 14).

In the above-described example, the example is described in which the digital camera 100 in the receiving mode sets the device ID according to the user operation on the communication setting screen as illustrated in FIG. 12C. The setting of device IDs is not limited to the above-described example, and for example, a value of the device ID assigned in advance to each of the digital cameras 100 may be stored in the flash memory 145, or the value assigned at the time of pairing registration may be stored in the buffer memory 125.

In the above-described example, the communication system 1 capable of setting the shooting setting and the shooting timing setting as the setting for the image shooting of the digital camera 100 is described. The setting for the image shooting in the present system 1 is not limited to the above-described example, and may be, for example, either the shooting setting or the shooting timing setting.

### 3. Summary

As described above, in the present embodiment, the digital camera 100-1 is an example of an electronic device capable of data communication with the digital cameras 100-2 to 100-4 as an example of a plurality of imaging apparatuses. The digital camera 100-1 includes the communication module 155 as an example of the communication circuit and the controller 135. The communication module 155 performs data communication with each digital camera 100 of the plurality of digital cameras 100-2 to 100-4. The controller 135 generates transmission data such as the advertising data D1,D11 and the scan response data D2, D12 each as an example of shooting setting data indicating a setting for the image shooting in the plurality of digital cameras 100-2 to 100-4 (S4). The controller 135 broadcasts the generated transmission data D1, D2, D11, and D12 to the plurality of digital cameras 100-2 to 100-4 in accordance with the BLE standard as an example of transmitting via broadcast communication, to configure the setting for the image shooting in the plurality of digital cameras 100-2 to 100-4, with a communication connection being unestablished with each of the digital cameras 100-2 to 100-4 via the communication module 155 according to the BLE standard, which is as an example of a predetermined communication standard (see S5, S6, and S7).

According to the digital camera 100-1 described above, the shooting setting data is broadcast in accordance with the BLE standard, with a communication connection according to the BLE standard being unestablished, and it is possible to easily set the setting for the image shooting in the plurality of digital cameras 100-2 to 100-4 concurrently. For example, the advertising data D1 and D11 are transmitted in the broadcast advertisement packet, and the scan response data D2 and D12 are transmitted in the scan response according to the scan request (S51 to S53).

In the present embodiment, the digital camera 100-1 further includes the image sensor 115 as an example of an image sensor that performs image shooting. The transmission data D1 and D2 as an example of the shooting setting data include a setting value in the setting for image shooting (see FIGS. 3, 8, and 9). The controller 135 generates the transmission data based on the setting value set in the digital camera 100-1 for image shooting by the image sensor 115 (S4). In this way, for example, the setting value in image shooting of the digital camera 100-1 can be shared with the plurality of digital cameras 100-2 to 100-4, and it is possible to facilitate shared shooting setting with the digital camera 100-1.

In the present embodiment, the digital camera 100-1 further includes the user interface 150 that receives a user operation. The transmission data D1 and D2 each as an example of the shooting setting data includes a setting value in the setting for the image shooting (see FIGS. 3, 8, and 9). The controller 135 generates changed transmission data D1 and D2, based on a changed setting value by the user operation that changes the setting value via the user interface 150(S8 and S9). In this way, the shooting setting according to the user operation in the digital camera 100-1 can be easily shared with the plurality of digital cameras 100-2 to 100-4 by broadcasting the transmission data D1 and D2.

In the present embodiment, the setting for image shooting is configured in the plurality of digital cameras 100-2 to 100-4 for a plurality of setting items as an example of a plurality of states corresponding to a plurality of settings for an image to be shot in each of the digital cameras 100 (see FIG. 5). As an example of storing a setting value in the setting for image shooting for each of the plurality of states, the transmission data D1 and D2 each stores a setting value for each setting item (see FIGS. 3, 5, 8, and 9). For example, in the transmission data D1 and D2, a setting value is stored for each setting tag ID designated by a value of the sub-tag ID for each setting item. In this way, for a plurality of setting items for the shooting setting, the setting values can be concurrently transmitted in the broadcast transmission data D1 and D2, and can be shared with the digital cameras 100-2 to 100-4 at onece, for example.

In the present embodiment, the transmission data D11 and D12 stores, in association with the device ID which is an example of an identifier identifying the plurality of digital cameras 100-2 to 100-4, a setting value in the setting for image shooting for each of the digital cameras 100 (see FIGS. 10 to 14). In this way, in the digital cameras 100-2 to 100-4 that have received the transmission data D11 and D12, the setting values associated with the respective device IDs are acquired, and the shooting timing can be set as an example of a setting for image shooting according to each setting value (see FIGS. 12A, 12B and 12C, S6 and S7).

In the present embodiment, the setting for the image shooting in the plurality of digital cameras 100-2 to 100-4 includes at least one of: the shooting setting as an example of a setting for an image to be shot in each of the imaging apparatuses; and the shooting timing setting as an example of a setting for a timing of image shooting in each of the digital cameras 100-2 to 100-4. The shooting setting includes at least one setting in image shooting for the ISO as an example of sensitivity, F-number as an example of an aperture value, shutter speed, exposure correction, and white balance (see FIG. 5). As described above, various settings for image shooting are possible, and this can also facilitate the setting for image shooting in the plurality of digital cameras 100-2 to 100-4.

In the present embodiment, the controller 135 of the digital camera 100-1 broadcasts the transmission data D1, D2, D11, and D12 by advertising in accordance with the BLE standard (S5). In such an advertisement according to the BLE standard, the shooting setting data such as the transmission data D1, D2, D11, and D12 can be broadcast without establishing a communication connection between the digital camera 100-1 and each of the digital cameras 100-2 to 100-4.

In the present embodiment, the communication system 1 includes the digital cameras 100-2 to 100-4 as an example of a plurality of imaging apparatuses, and the digital camera 100-1 as an example of an electronic device capable of performing data communication with the plurality of digital cameras 100-2 to 100-4. The digital camera 100-1 generates the transmission data D1, D2, D11, and D12 each as an example of shooting setting data indicating a setting for image shooting in the plurality of digital cameras 100-2 to 100-4 (S4), and broadcasts the generated transmission data D1, D2, D11, and D12 to the plurality of digital cameras 100-2 to 100-4 in accordance with the BLE standard, as an example of transmitting the generated shooting setting data via broadcast communication with a communication connection being unestablished with each of the digital cameras 100 according to the BLE standard, which is as an example of a predetermined communication standard (S5). Each of the digital cameras 100 that are the plurality of digital cameras 100-2 to 100-4 receives the shooting setting data broadcast from the digital camera 100-1, and changes the setting for image shooting based on the received shooting setting data (S6 and S7).

In the communication system 1 according to the present embodiment, , a program stored in is provided which is executed by, as an example of a controller of a computer, the controller 135 of the digital camera 100 to cause the digital camera 100 to function as the above-described digital camera 100-1. According to the communication system 1 and the program as described above, similarly to that described above for the digital camera 100-1, it is possible to facilitate the setting for the image shooting in the plurality of digital cameras 100-2 to 100-4, for example.

### Second Embodiment

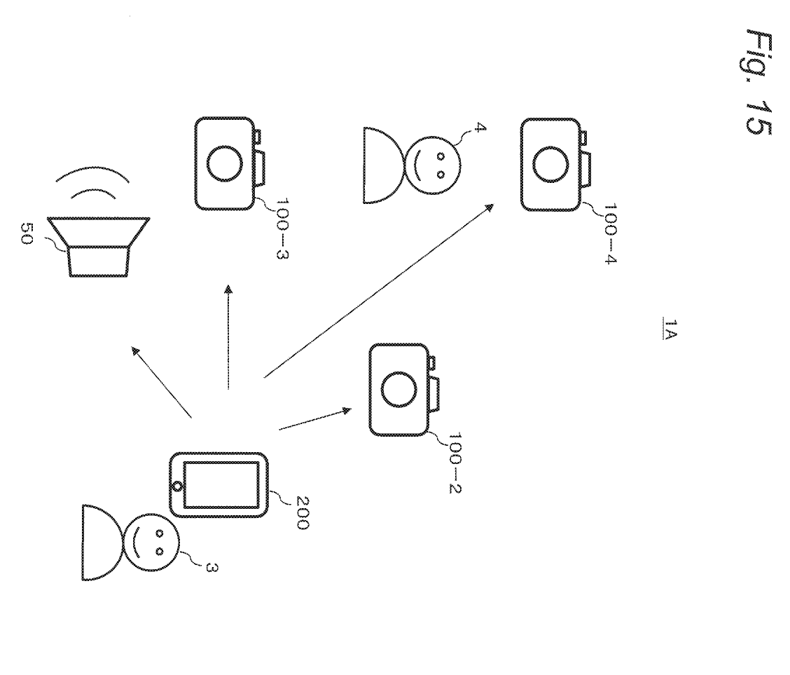

A second embodiment of the present disclosure will be described below with reference to FIGS. 15 to 22. In the first embodiment, the communication system 1 that sets the setting for the image shooting in the plurality of digital cameras 100 is described. In a second embodiment, a communication system that further includes an audio device capable of outputting a sound and configures a setting for image shooting for creation of a video work with a sound will be described.

Description of the same configuration and operation as those of the communication system 1 according to the first embodiment will be appropriately omitted, and the communication system according to the present embodiment will be described.

### 1. Configuration

FIG. 15 is a diagram illustrating a configuration of a communication system 1A according to the second embodiment. For example, as illustrated in FIG. 15, the present system 1A includes an audio device 50 such as an audio player and a control terminal 200 such as a smartphone operated by a user 3 of the present system 1A in addition to the digital cameras 100-2 to 100-4.

In the present system 1A, for example, the digital cameras 100-2 to 100-4 are arranged so as to shoot images of a subject 4, such as an actor in the video work, from different directions. For example, the digital cameras 100-2, 100-3, and 100-4 are arranged so as to shoot images of a side surface, a front surface, and a back surface of the subject 4, respectively. For example, the present system 1A can be used for video creation in which the plurality of digital cameras 100-2 to 100-4 shoot videos of the subject 4 moving according to music, with the user 3 causing the audio device 50 to output a sound of the music.

In the present system 1A, for example, as a setting for the video shooting in such video creation, a setting for video creation in each of the digital cameras 100-2 to 100-4 and the audio device 50 is set based on transmission data broadcast from the control terminal 200. Although FIG. 15 illustrates the communication system 1A including the three digital cameras 100, the present system 1A may include, for example, two or four or more digital cameras 100.

### 1-1. Configuration of Control Terminal

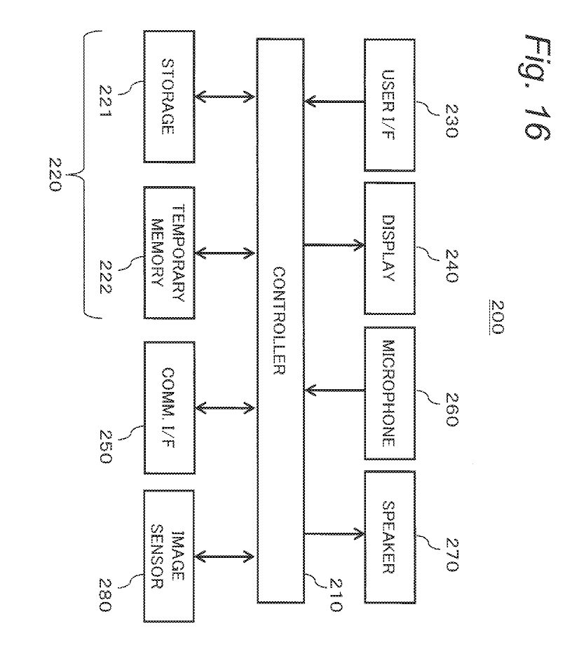

A configuration of the control terminal 200 according to the present embodiment will be described with reference to FIG. 16.

FIG. 16 is a diagram illustrating the configuration of the control terminal 200. The control terminal 200 illustrated in FIG. 16 includes a controller 210, a storage/memory 220, a user interface 230, a display 240, a communication interface 250, a microphone 260, a speaker 270, and an image sensor 280. The "interface" is abbreviated as "I/F" as appropriate.

The controller 210 includes, for example, a CPU or an MPU that implements a predetermined function in cooperation with software. The controller 210 controls the overall operation of the control terminal 200, for example. The controller 210 reads data and a program stored in the storage/memory 220, performs various arithmetic processing, and implements various functions.

The controller 210 executes, for example, a program including a command group for implementing each of the above-described functions. The program may be provided from a communication network such as the Internet, or may be stored in a portable recording medium. Further, the controller 210 may be a hardware circuit, such as a dedicated electronic circuit or a reconfigurable electronic circuit, designed to implement each of the above-described functions. The controller 210 may include various semiconductor integrated circuits such as a CPU, an MPU, a GPU, a GPGPU, a TPU, a microcomputer, a DSP, an FPGA, and an ASIC.

The storage/memory 220 is a storage medium that stores the program and data necessary for implementing the functions of the control terminal 200. As illustrated in FIG. 3, the storage/memory 220 includes a storage 221 and a temporary memory 222.

The storage 221 stores a parameter, data, a control program, and the like for implementing a predetermined function. The storage 221 includes, for example, an HDD or an SSD. For example, the storage 221 stores the above-described program and the like.

The temporary storage 222 includes, for example, a RAM such as a DRAM or an SRAM, and temporarily stores (i.e., holds) data. For example, the temporary storage 222 holds image data that is being edited. In addition, the temporary storage 222 may function as a work area of the controller 210, and may be a storage area in an internal memory of the controller 210.

The user interface 230 is a general term for operation members operated by a user. The user interface 230 is, for example, a touch panel stacked with the display 240 to input various touch operations, and is an example of an input interface of the control terminal 200. The input interface may be a connection interface that is implemented with software and is communicably connected to various external input devices and receives an operation signal. The user interface 230 may be a physical button, a switch, or the like disposed in the control terminal 200, or a keyboard, a mouse, a touch pad, or the like may be used. The user interface 230 may be various GUIs such as virtual buttons, icons, cursors, software keyboards, and objects displayed on the display 240.

The display 240 includes, for example, a liquid crystal display or an organic EL display. The display 240 may display various types of information such as various GUIs for operating the user interface 230 and information input from the user interface 230.

The communication interface 250 is a module (circuit) that is connected to an external device in accordance with a predetermined communication standard including, for example, Bluetooth. The predetermined communication standard may be another standard in wired or wireless communication, and examples of the predetermined communication standard include, for example, USB, HDMI, IEEE802.11, Wi-Fi, and the like. The communication interface 250 may connect the control terminal 200 to a communication network such as the Internet. The communication interface 250 is an example of an acquisition interface that receives various types of information from an external device or a communication network.

The microphone 260 includes, for example, one or more microphone elements built in the control terminal 200. The microphone 260 outputs an audio signal indicating a collected sound to the controller 210. The control terminal 200 may include a connector, such as a terminal that is connected to an external microphone, instead of or in addition to the built-in microphone 260.

The speaker 270 includes, for example, one or more speaker elements built in the control terminal 200, and outputs a sound to the outside of the control terminal 200 under control by the controller 210. The control terminal 200 may include a connector that is connected to an external speaker, earphone, or the like, instead of or in addition to the built-in speaker 270. Each of the speaker 270 and the connector are an example of an output circuit in the present embodiment.

The image sensor 280 is implemented by, for example, an optical system, an image sensor, and the like. The optical system includes various lenses, a diaphragm, a shutter, and the like. The image sensor is, for example, a CCD image sensor, a CMOS image sensor, or the like, and captures a subject image formed via an optical system to generate imaging data. The imaging data constitutes image data indicating the image captured by the image sensor. The image sensor generates image data of a new frame at a predetermined frame rate (e.g., 30 frames per second). The timing of generating the imaging data and an electronic shutter operation in the image sensor of the image sensor 280 are controlled by the controller 210. A lens in an optical system of the image sensor 280 may include a focus lens, a zoom lens, and/or the like.

In the control terminal 200 according to the present embodiment, the image sensor 280 includes, for example, an in-camera disposed on a surface having the display 240 and an out-camera disposed on a surface facing the surface on the display 240 side. Further, in the control terminal 200, the controller 210 may perform various types of processing on the imaging data output from the image sensor of the image sensor 280 to generate the image data, or may perform various types of processing on the image data to generate an image to be displayed on the display 240.

The configuration of the control terminal 200 as described above is an example, and the configuration of the control terminal 200 is not limited thereto. For example, various display devices such as a projector and a head mounted display may be used as the display 240 of the control terminal 200. Further, for example, in a case where an external display device is used, the display 240 of the control terminal 200 may be, for example, an output interface circuit for a video signal or the like conforming to an HDMI standard or the like.

### 1-2. Configuration of Audio Device

The audio device 50 of the present system 1A has a configuration similar to that of the control terminal 200 illustrated in FIG. 16, for example, and can be constituted by various computers. The audio device 50 is an example of a sound reproduction device in the present embodiment. For example, sound source data indicating a sound of music is stored in a storage of the audio device 50. The audio device 50 outputs a sound from a speaker based on the sound source data and reproduces a sound of music. The audio device 50 may not include a built-in microphone. Instead of or in addition to the built-in speaker and the display, the audio device 50 may include a connector that is connected to an external speaker, or may include an output interface circuit for, for example, an audio signal and/or a video signal.

### 1-3. Advertising Data

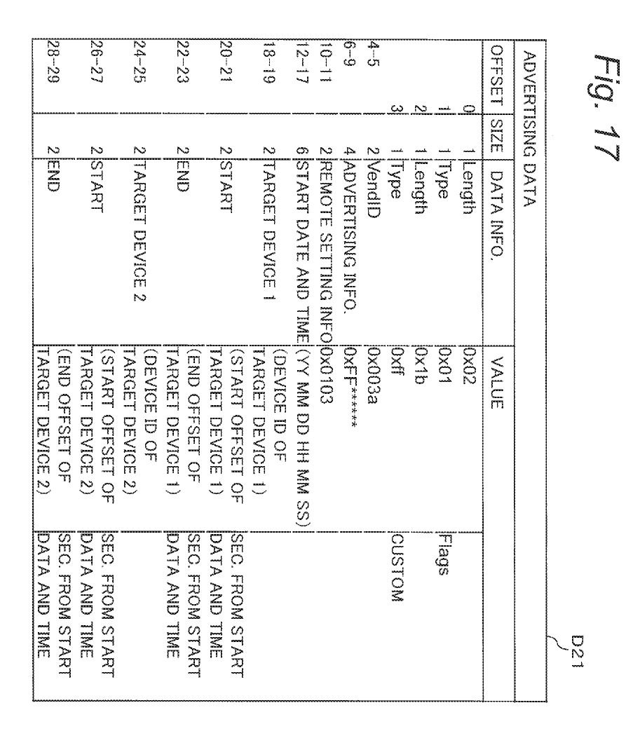

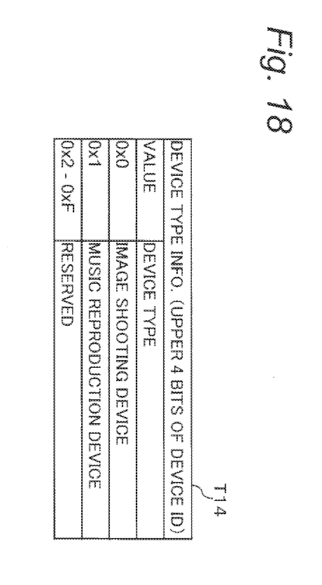

Advertising data in the present system 1A will be described with reference to FIGS. 17 and 18.

In the present system 1A, for example, similarly to the advertising data D11 (FIG. 10) for the shooting timing setting, the advertising data identifying the target device for the video creation setting based on the device ID is used. FIG. 17 is a diagram illustrating a data structure of advertising data D21 in the present system 1A.

In the advertising data D21, for example, the remote setting information is changed from the advertising data D11 for the shooting timing setting to a value indicating the video creation setting illustrated in the notification setting information T11 (FIG. 4A). Further, in the advertising data D21, for each target device, a start offset and an end offset for each target device are stored instead of the number of images to be shot and the shooting interval in the advertising data D11.

For example, in a case where the target device is the digital camera 100, the start offset and the end offset indicate elapsed times from the shooting start date and time to the start and end of video shooting by the target device, respectively. In a case where the target device is the audio device 50, for example, the start offset and the end offset indicate reproduction timings such as elapsed times from the shooting start date and time to the start and end of sound output so that music reproduction is performed in synchronization with video shooting. In the present system 1A, for example, the type of the target device such as the digital camera 100 or the audio device 50 is identified based on device type information for managing each device type.

FIG. 18 is a diagram for explaining device type information T14 in the present system 1A. For a device type, for example, each value indicating an “image shooting device” such as the digital camera 100 and a “music reproduction device” such as the audio device 50 is set as a value in upper 4 bits of the device ID. The device type information T14 may be stored in advance in the storage 221 of the control terminal 200, for example, or may be acquired from outside of the control terminal 200 via the communication interface 250. For example, in a case where the notification setting information (see FIG. 4A) is a value indicating the video creation setting in the remote setting information of the advertising data D21, the music reproduction device may be enabled as a selectable device type in the present system 1A.

### 2. Operation

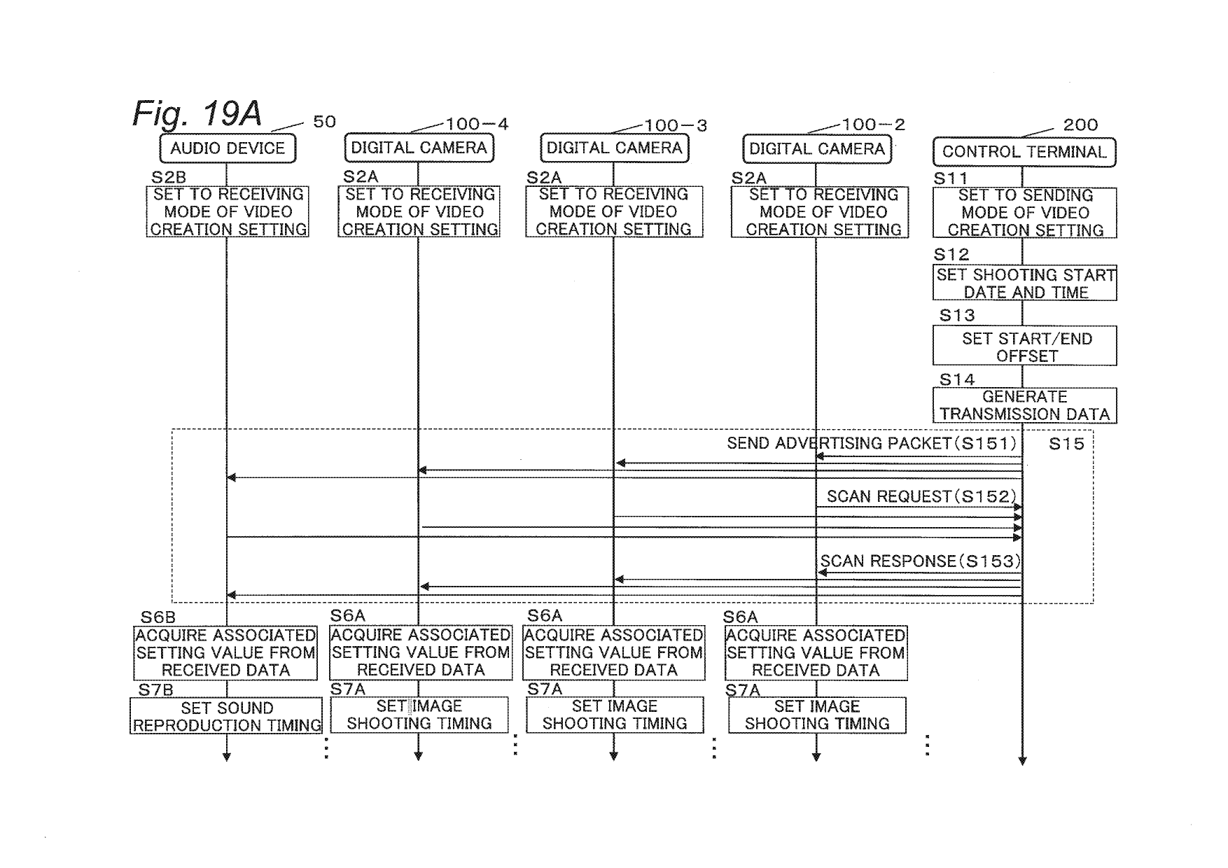

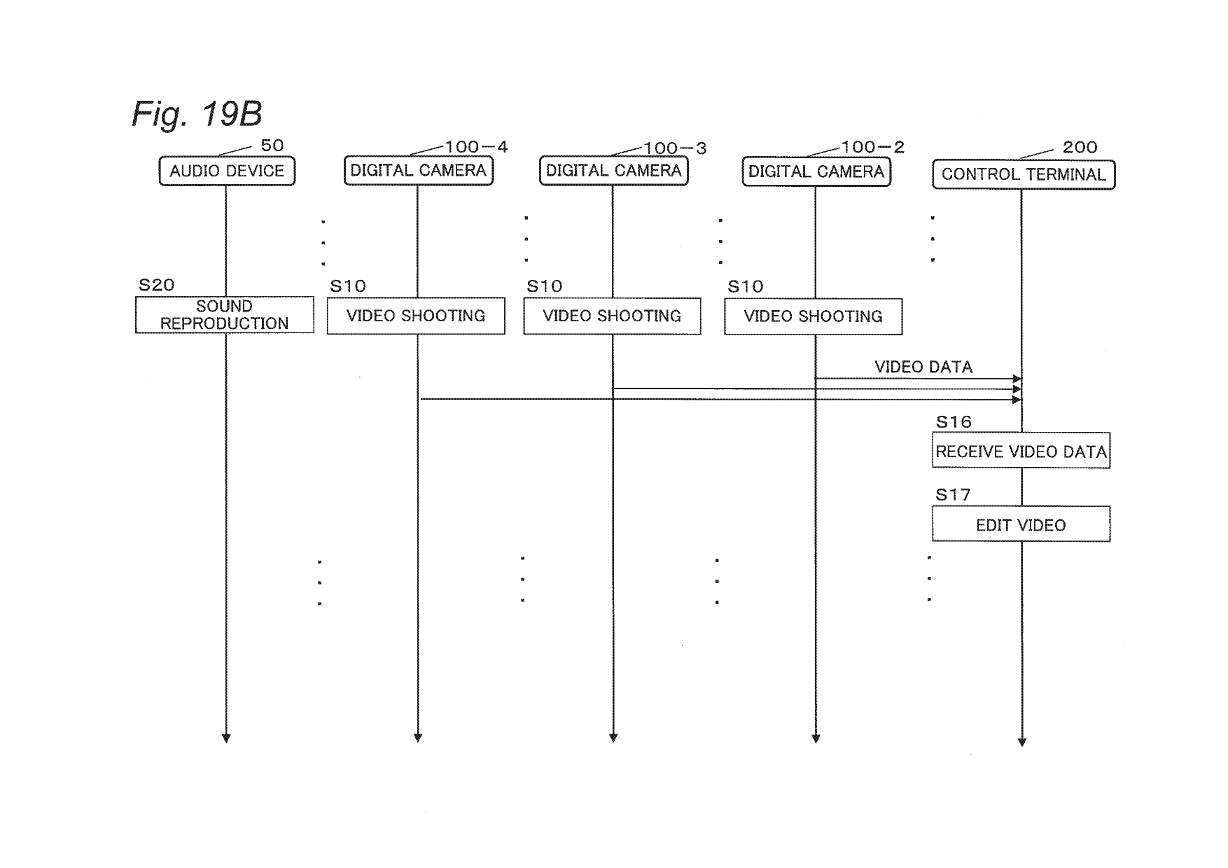

The operation of the present system 1A configured as described above will be described below with reference to FIGS. 19A and 19B to 22.

FIGS. 19A and 19B are sequence diagrams each illustrating an operation for the video creation setting in the present system 1A. In the present system 1A, the digital camera 100, the control terminal 200, and the audio device 50 have setting modes such as the sending mode and the receiving mode for the video creation setting, for example, similarly to the setting modes for the shooting setting and the shooting timing setting in the communication system 1 according to the first embodiment.

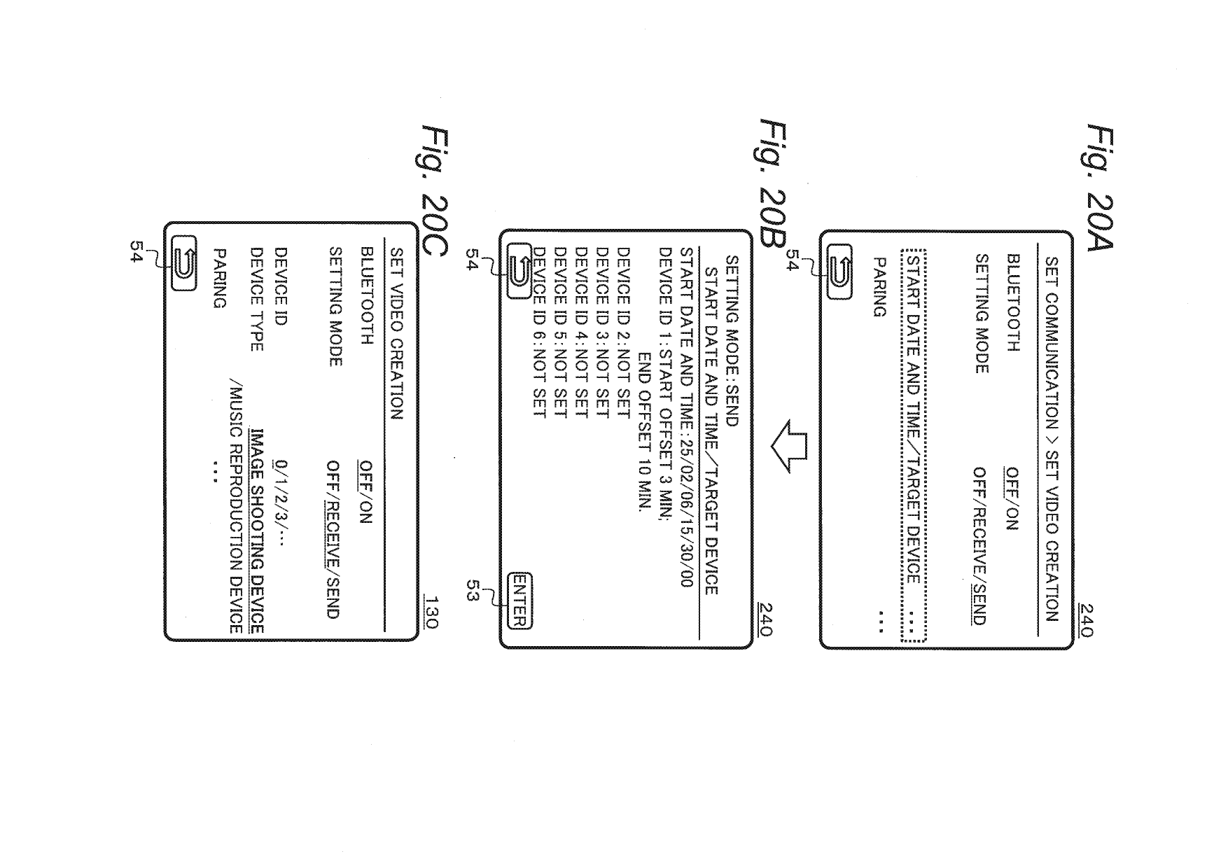

For example, the control terminal 200 displays a communication setting screen for the video creation setting on the display 240 in response to a predetermined user operation. FIGS. 20A, 20B and 20C are diagrams each illustrating a display example of the communication setting screen for the video creation setting in the present system 1A. The controller 210 of the control terminal 200 sets the setting mode of the control terminal 200 to the sending mode for the video creation setting in response to the user operation input via the user interface 230 on the communication setting screen as illustrated in FIG. 20A, for example (S11). FIG. 20A illustrates an example in which the sending mode is selected from the options for the setting mode, and the “shooting start date and time/target device setting” is further displayed.

The controller 210 of the control terminal 200 receives, via the user interface 230, a user operation of setting a start date and time of video shooting and a target device for the video creation setting. For example, a setting screen for the shooting start date and time and the like as illustrated in FIG. 20B is displayed in response to a user operation of selecting the option of “shooting start date and time/target device setting” in FIG. 20A. For example, on the setting screen illustrated in FIG. 20B, the controller 210 receives, via the user interface 230, a user operation of setting the start offset and the end offset for each device ID in the target device in addition to the shooting start date and time (S12 and S13).

Further, each of the digital cameras 100-2 to 100-4 sets the setting mode of the digital camera to the receiving mode for the video creation setting in response to a user operation on a communication setting screen as illustrated in FIG. 20C, for example (S2A). FIG. 20C illustrates the communication setting screen on which the receiving mode is selected and options for device IDs and options for device types are displayed in the digital camera 100. For example, when the receiving mode is set, each of the digital cameras 100-2 to 100-4 displays the options for the device IDs and the options for the device types, and receives a user operation of selecting one of the options for the device IDs and one of the options for the device types, thereby setting the device ID and the device type of the digital camera.

Further, in the present system 1A, the audio device 50 sets the setting mode of the audio device 50 to the receiving mode for the video creation setting in response to a predetermined user operation on the user interface, for example (S2B). For example, the audio device 50 displays, on the display, a communication setting screen similar to that of the digital camera 100 as illustrated in FIG. 20C, and sets the device ID and the device type in response to the user operation when the receiving mode is set.

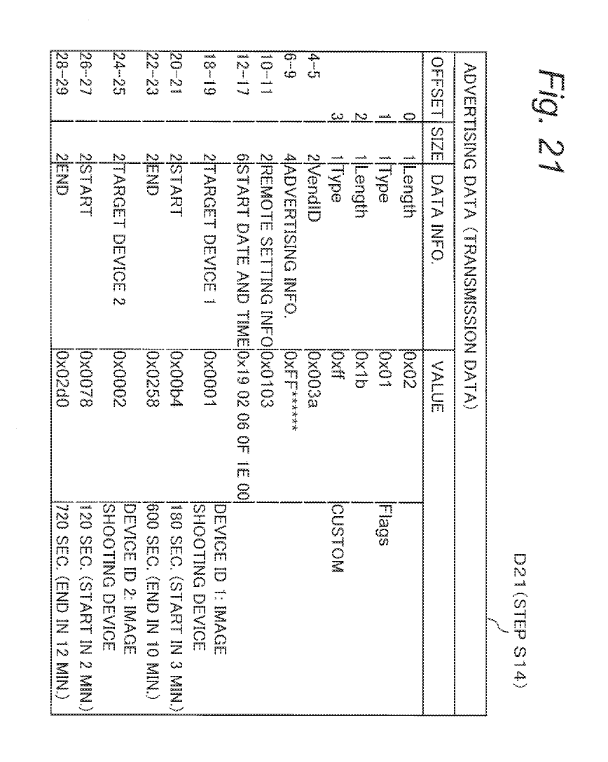

The controller 210 of the control terminal 200 determines the shooting start date and time and start and end offsets for each target device in response to a user operation on the enter button 53 on the setting screen illustrated in FIG. 20B, for example, and then generates the transmission data such as the advertising data D21 (S14). For example, similarly to step S4 in FIG. 6, when the Bluetooth function is enabled in the sending mode, the transmission data is generated. FIG. 21 illustrates the advertising data D21 generated as the transmission data in step S14. In the example illustrated in FIG. 21, in addition to the shooting start date and time and the setting values for the target device 1 as illustrated in FIG. 20B, setting values of the device ID, the start offset, and the end offset for the target device 2 are further stored.

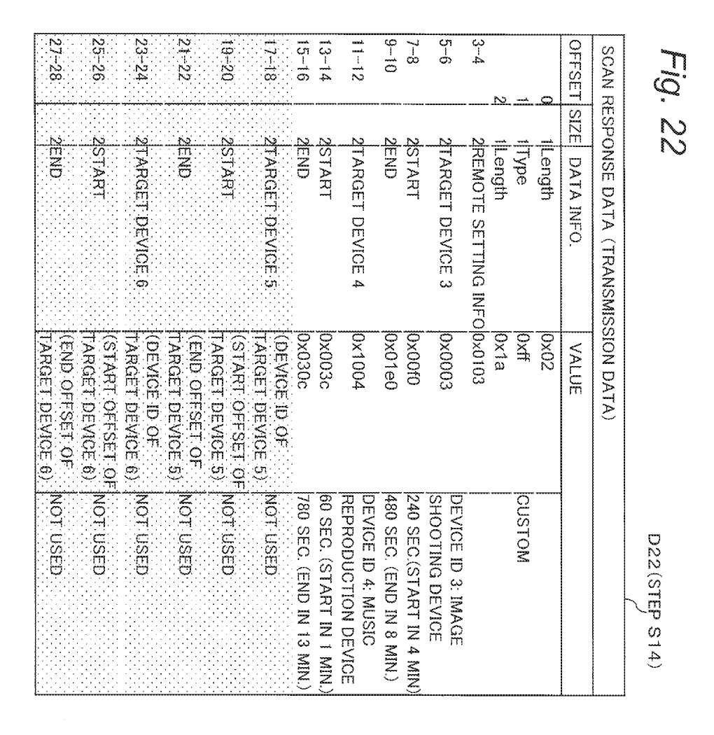

Further, in the present example, the scan response data is further generated as the transmission data according to the extended setting (see FIG. 4B) in the remote setting information of the advertising data D21 (S14). FIG. 22 is a diagram illustrating scan response data D22 for the video creation setting. The scan response data D22 stores setting values of the start offset and the end offset instead of the number of images to be shot and the shooting interval in the scan response data D12 (FIG. 14) for the shooting timing setting, for example. In the example illustrated in FIG. 22, in addition to the target device 3 set as the image shooting device similarly to the target devices 1 and 2 in the advertising data D21, a setting value for the music reproduction device corresponding to the audio device 50 is stored as a target device 4.

The controller 210 of the control terminal 200 broadcasts the generated transmission data D21 and D22 (S15). The controller 210 transmits the advertising data D21 in the advertisement packet via the communication interface 250 (S151). The controller 210 transmits, in response to receiving the scan request (S152), the scan response data D22 in the scan response (S153). In the present example, the digital cameras 100-2 to 100-4 and the audio device 50 that have received the advertisement packet transmit the scan request to the control terminal 200.

The controller 135 of each of the digital cameras 100-2 to 100-4 receives the advertising data D21 and the scan response data D22, and acquires a setting value corresponding to, or associated with the digital camera from the received data D21 and D22 by referring to the device ID (S6A). In step S6A, the device type may be further referred to. In each of the digital cameras 100, the controller 135 sets the shooting timing according to the start and end offsets from the shooting start date and time based on the acquired setting value (S7A).

Further, for example, similarly to steps S6A and S7A, the audio device 50 acquires the setting value corresponding to the audio device from the received data D21 and D22 (S6B), and sets a sound reproduction timing according to the start and end offsets from the shooting start date and time based on the setting value (S7B).

The controller 135 of each of the digital cameras 100 starts and ends video shooting by the image sensor 115 at the shooting timing set in step S7A (S10 in FIG. 19B). In the present system 1A, the controller 135 transmits video data, which is a result of the video shooting, to the control terminal 200 via the communication module 155, for example. Further, the audio device 50 starts and ends outputting of sound at the reproduction timing set in step S7B (S20).

The controller 210 of the control terminal 200 receives video data, which is a result of imaging, from each of the digital cameras 100 via the communication interface 250 (S16). The controller 210 displays the video data on the display 240, for example, and receives a user operation of editing the video data on the user interface 230 (S10).

According to the above-described operation of the present system 1A, the control terminal 200 broadcasts the transmission data D21 and D22 (S15), and sets the shooting timing in the digital cameras 100-2 to 100-4 and the reproduction timing in the audio device 50 (S6A to S7B). According to the advertising data D21 and the scan response data D22 as the transmission data, for example, in addition to the setting for each of the digital cameras 100, the setting can also be configured on the audio device 50 according to the device ID and the device type concurrently (see FIGS. 17, 18 and 20 to 22)).

In each of the digital cameras 100 and the audio device 50, video shooting and sound output are performed according to the start and end offsets set by broadcasting the transmission data D21 and D22 (S10 and S20). In the present system 1A, the control terminal 200 receives the video data, which is the result of the imaging by each of the digital cameras 100 (S16), and edits the video data (S17). In this way, it is possible to easily shoot a video in accordance with a sound by the plurality of digital cameras 100 at a timing intended by the user, and to easily create a video work desired by the user.

Although the example in which the transmission data is generated in response to enabling the Bluetooth function is described above (S14), the transmission data may be generated in response to a predetermined user operation in a state where the function is enabled. In this case, for example, the function may be set to ON in step S11.

### 3. Modifications

In the above description, the example is described in which the communication system 1A sets the start and end offsets in response to the user operation on the communication setting screen as illustrated in FIG. 20. In the present system 1A, the setting is not limited to the example illustrated in FIG. 20, and may be set in conjunction with various settings in video creation, for example. A modification of the communication system 1A described above will be described below.

The communication system 1A according to the present modification can be used for creation of a desired video work, such as a music video or a dance video, by shooting and editing a plurality of videos in accordance with music by a user, for example. The present system 1A provides information support useful for a series of workflows in which, for example, the user creates a plan indicating a concept of video shooting according to the music, repeats video shooting according to the created plan, and edits a plurality of shot videos. The control terminal 200 of the present system 1A has, for example, a plan creation function and a video management function as various functions for sequentially providing information support to the user in creation of the video work.

The plan creation function is a function providing information support for a process in which the user creates a plan before shooting a video. The control terminal 200 manages various types of information for each angle at which a video is shot according to the created plan. The angle constitutes a shooting unit such as a unit for managing video shooting by each of the digital cameras 100 according to a period in music, for example. The video management function is a function of supporting management of a result of shooting a video at each angle in the plan created by the plan creation function. The number of times of shooting a video at one angle is not limited to one, and may be, for example, plural when video shooting is repeated.

### 3-1. Plan creation function

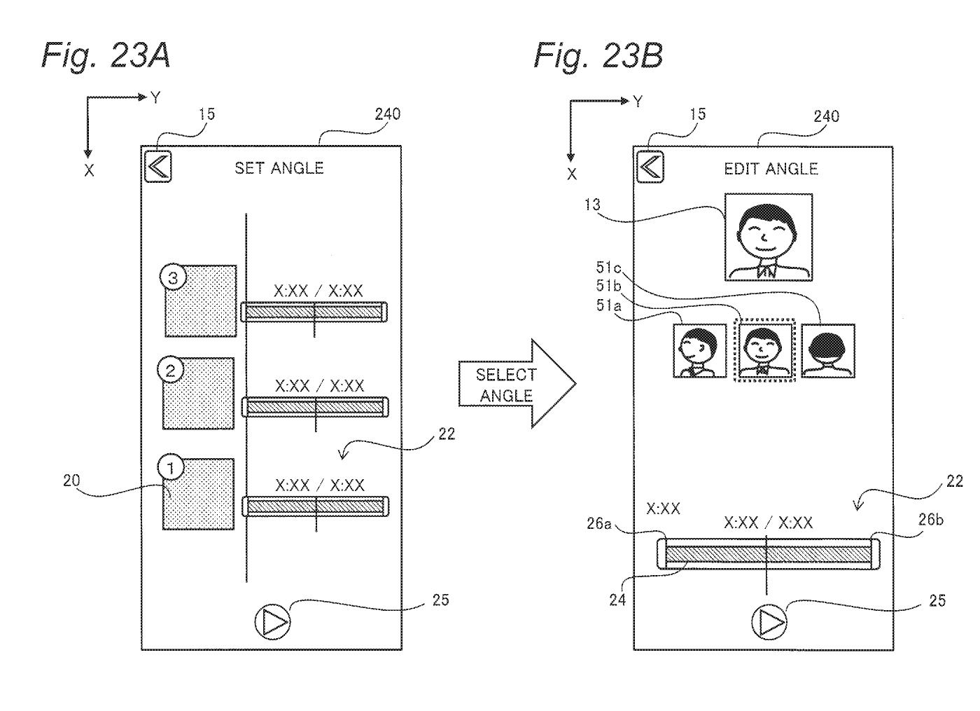

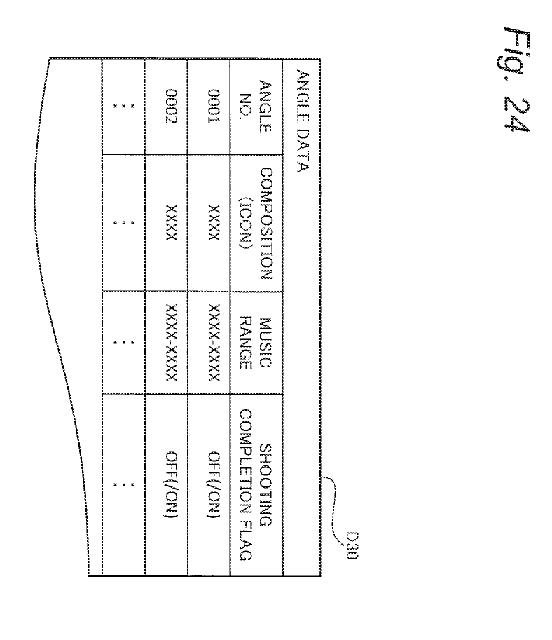

The plan creation function in the control terminal 200 will be described with reference to FIGS. 23 and 24.

The plan creation function according to the present embodiment includes, for example, functions of music selection, music range setting, and angle setting. The functions are a function of selecting music to be reproduced in a video work, a function of specifying a range included in the video work from a period of the music selected by the music selection function, and a function of setting an angle in video shooting in association with sound source data indicating the music. In the present system 1A, the angle is an example of a shooting unit for managing how video shooting according to the music is performed using the plurality of digital cameras 100 in association with a specified range within a period of the music in the sound source data.

The control terminal 200 stores, into the storage/memory 220, a music range set as a range to be reproduced in the video work from the music selected by the user, in association with the sound source data by functions of music selection and music range setting, for example. The music range may be set to the entire period of the music in the sound source data as an initial setting. Further, the control terminal 200 executes the angle setting function and displays, on the display 240, an angle setting screen as illustrated in FIG. 23A.

The angle setting screen illustrated in FIG. 23A includes a reproduction button 25 and a return button 15 in addition to an angle setting field 20 and a reproduction field 22 for each angle. In the control terminal 200, the angle setting field 20 receives a user operation of selecting the angle to be edited, and the reproduction field 22 receives a user operation of specifying the range to be associated with a video from a period such as a reproduction time of the sound source data of the music. In addition, sound output by the speaker 270 or the like is started or stopped by the operation of the reproduction button 25.

The controller 210 of the control terminal 200 causes the display 240 to transition to an angle editing screen as illustrated in FIG. 23B in accordance with, for example, a user operation of selecting the angle setting field 20 for each angle on the angle setting screen. The angle editing screen is a screen for editing a selected angle, and includes, for example, an angle icon 13, preset icons 51a, 51b, and 51c, a reproduction field 22, a reproduction button 25, and a return button 15.

The angle icon 13 indicates a composition for shooting an image of a subject in video shooting at each angle, and is set for each angle. Further, the range designated by a marker 26 on an audio timeline 24 in the reproduction field 22 for each angle is set for each angle. A marker 26a and a marker 26b indicate a start point and an end point of the range designated from the period of the music, respectively, and are moved on the audio timeline 24 according to a drag operation or the like. For example, a plurality of angles can be set in mutually overlapping ranges in the period of the music. Each of the angle setting screen and the angle editing screen is an example of a setting interface in the present modification, and is implemented by cooperation of the user interface 230 and the display 240, for example, when the controller 210 executes a program stored in the storage 221.

The preset icon 51 on the angle editing screen is displayed as an option of the angle icon 13. In the present system 1A, the preset icon 51 is registered in advance as a template of a composition such as a shooting direction with respect to the subject 4 in video shooting. For example, preset icons 51a to 51c correspond to the arrangement of the digital cameras 100-2 to 100-4 in the present system 1A as illustrated in FIG. 15, respectively, and indicate compositions for shooting images of the side surface, the front surface, and the back surface of the subject 4, respectively.

The controller 210 of the control terminal 200 generates angle data including input angle setting information according to various user operations on the angle setting screen and the angle editing screen (FIG. 23). FIG. 24 illustrates the angle data stored in the storage 221 after the end of the angle setting processing. In the present system 1A, the angle data is an example of management information managing the video shot in association with the sound source data.

FIG. 24 is a diagram illustrating a data structure of angle data D30 in the control terminal 200. The angle data D30 manages the “composition”, the “music range”, and an “imaging completion flag” in association with each other for each “angle number” indicating identification information of the angle. For example, angle numbers are assigned to a plurality of angles sequentially set on the angle setting screen in FIG. 23A in ascending order of starting points of the music range.

The composition indicated by the angle icon 13 on the angle editing screen and the music range designated in the reproduction field 22 are recorded in the “composition” and the “music range” of the angle data D30, respectively. The music range for each angle is managed based on, for example, timings of starting and ending reproduction. The timings of starting and ending the reproduction correspond to the start point and the end point designated by the markers 26a and 26b of the reproduction field 22, respectively. The “shooting completion flag” is set to ON or OFF to manage whether video shooting is completed for each angle is in a . At the end time of the angle setting processing, the imaging completion flag is set to OFF for all the angles as an initial setting.

According to the plan creation function described above, the angle data D30 including the music ranges for the respective angles, the composition for video shooting, and the like is generated based on user inputs on the angle setting screen and the angle editing screen illustrated in FIG. 23. For example, the angle data D30 illustrated in FIG. 24 is used to manage, for each angle at which each of the digital cameras 100 shoots a video, the shooting timing of each of the digital cameras 100 according to a corresponding music range. In the communication system 1A according to the present modification, after the execution of the plan creation function, the video creation setting and the video management function by the control terminal 200 are executed.

### 3-2. Video creation setting and video management function

In the present modification, instead of setting the start and end offsets using the communication setting screen (FIG. 20), the control terminal 200 sets the respective offsets based on the angle data D30 (S13 in FIG. 19A). Further, in the communication system 1A according to the present modification, in steps S10 and S20, the digital camera 100 shoots a video and the audio device 50 reproduces yhe music according to the start and end offsets set based on the angle data D30.

For example, for each angle in the angle data D30, the controller 210 of the control terminal 200 sets the start and end offsets for video shooting in the advertising data D21 and the scan response data D22, based on the music range of the angle, for the digital camera 100 corresponding to the shooting direction of video shooting in the set composition. For example, a start point of the music range in the video work is synchronized with the shooting start date and time, and start and end offsets for video shooting are set based on differences of the start point and the end point of the music range set for each angle from the shooting start date and time set in step S12.

Furthermore, the controller 210 sets the start and end offsets for sound output in the audio device 50 using the start point and the end point of the music range for a plurality of angles in the angle data D30. For example, the start and end offsets of the audio device 50 are set based on differences of the earliest start point and the latest end point among the music ranges, for the respective angles set in the angle data D30, from the shooting start date and time set in step S12. The start offset for the sound output may be set to a time point earlier by a predetermined period from the earliest start point of the music range, and the end offset for the sound output may be set to a time point later by a predetermined period from the latest end point of the music range.

Further, the control terminal 200 manages the result of the imaging received from each of the digital cameras 100 in step S16 by the video management function. For example, the control terminal 200 receives a user's evaluation for a video of each take shot at each angle, and manages whether video shooting is completed for the angle by the shooting completion flag in the angle data D30 according to the evaluation.

For example, in a case where the user evaluates each take as “OK” indicating that the user wants to use the take for the corresponding angle, the shooting completion flag for the angle is set to “ON”. For example, in the creation of the video such as a dance video, in a case where a take of a video shooting result for each angle by each of the digital cameras 100 is evaluated as “OK”, it is only required to shoot a video of a single dance performance by an actor as the subject 4, and video shooting can be efficiently performed.

As described above, according to the communication system 1A according to the present modification, for example, the start and end timings for each of the digital cameras 100 and the audio device 50 can be set by broadcasting based on the angle data D30 set in the control terminal 200 (S14 and S15). According to the video creation setting, for example, each timing can be collectively set according to the music range set by the user according to the video creation plan. This also makes it easy to concurrently configure the setting for the video shooting in the plurality of digital cameras 100.

Further, according to the communication system 1A according to the present modification, for example, even in a case where the user 3 shoots a video alone, it is not required to set each timing in shooting a video for each angle, and it facilitates video shooting using the plurality of digital cameras 100 and the audio device 50. In this way, for example, it is possible to easily shoot a video at a plurality of angles and to improve a workflow in video creation.

### 4. Summary

As described above, in the present embodiment, the plurality of digital cameras 100-2 to 100-4 include the digital camera 100-2 and the digital camera 100-3 as examples of a first imaging apparatus and a second imaging apparatus that are arranged with different directions from each other to shoot images of the subject 4 by the first imaging apparatus and the second imaging apparatus (see FIG. 15). The controller 210 in the control terminal 200 as an example of the electronic device broadcasts, to the digital cameras 100-2 and 100-3, the transmission data D21 and D22 as an example of the shooting setting data including the setting values for each of the digital cameras 100-2 and 100-3 in association with the device IDs, to configure the video creation setting as an example of the setting for image shooting in each of the digital cameras 100-2 and 100-3 in accordance with the device IDs (see S15, S6A, and S7A). In this way, for example, the video creation setting can be easily set concurrently in each of the digital cameras 100-2 and 100-3 and the like from the control terminal 200, and it is possible to easily perform the video creation using the plurality of digital cameras 100.

In the present embodiment, in addition to the digital cameras 100-2 and 100-3, for example, the communication interface 250 of the control terminal 200 further performs data communication with the audio device 50 as an example of a sound reproduction device that outputs a sound based on sound source data (see FIG. 15). The digital cameras 100-2 and 100-3 perform video shooting as an example of moving image shooting on the subject 4 based on the shooting setting data (see S6A and S7A), and the setting for image shooting includes a setting for a timing at which the sound indicated by the sound source data is output by the audio device 50 in the video shooting (see FIG. 22). For example, as illustrated in FIG. 22, the timing of sound output can be set based on the start and end offsets from the shooting start date and time. In this way, for example, it is possible to easily shoot a video in creating a video work with a sound. In the above description, the example is described in which the start and end offsets for the video shooting and the sound output are set based on the elapsed time from the shooting start date and time, but the shooting timing or reproduction timing for each target device may be set based on the start and end dates and times.

In the modification of the present embodiment, the sound source data indicates a sound of music. The control terminal 200 further includes an angle setting screen and an angle editing screen (FIGS. 23A and 23B) each as an example of a setting interface. The setting interface sets an angle, as an example a shooting unit, for the video shooting by each of the digital cameras 100-2 and 100-3 in the angle data D30 as an example of management information for a video associated with the sound source data, the angle being set in association with the music range as an example of a period in the music (FIG. 23). The angle data D30 is used to manage, for each angle by each of the digital cameras 100-2 and 100-3, a timing of shooting a video according to the associated music range (FIG. 24). The controller 210 generates the transmission data D21 and D22 based on the angle data D30 set by the setting interface (see S13 and S14). Although the example in which the video creation setting is set after the execution of the plan creation function is described above, the plan creation function may be executed in step S13 of the video creation setting, for example.

In the first and second embodiments described above, the transmission data D11, D12, D21 and D22 each as an example of the shooting setting data store, in association with the devices ID each as an example of an identifier identifying the plurality of digital cameras 100-2 to 100-4 (an example of a plurality of imaging apparatuses), the setting values in the shooting timing setting and the video creation setting are stored for each of the digital cameras 100 as an example of the setting for the image shooting (see FIGS. 10, 13, 14, 17, 21, 22, 11, and 18).. The digital camera 100-1 or the control terminal 200 as an example of the electronic device broadcasts, to the plurality of digital cameras 100-2 to 100-4, the transmission data D11, D12, D21, and D22 each as an example of shooting setting data generated by associating, for each of the digital cameras 100, the setting value in image shooting with the device ID (S5 and S15). Each digital camera 100 of the plurality of digital cameras 100-2 to 100-4 acquires the setting value associated with the digital camera 100 based on the device ID from the received shooting setting data (see S6A and S6), and applies the acquired setting value to the setting for image shooting (see S7A and S7). In this way, for example, it is possible to set configure setting for the image shooting for each of the digital cameras 100-2 to 100-4 concurrently from the digital camera 100-1 or the control terminal 200.

### Other Embodiments

The first and second embodiments are described above as an example of the techniques disclosed in the present application. However, the techniques in the present disclosure are not limited thereto, and can also be applied to embodiments in which changes, substitutions, additions, omissions, and the like are made as appropriate. In addition, a new embodiment can be made by combining the components described in the first embodiment. Therefore, other embodiments will be exemplified below.

In the first embodiment, for example, as illustrated in FIGS. 1 and 6, the example is described in which the digital camera 100-1 is set to the sending mode and the digital cameras 100-2 to 100-4 are set to the receiving mode in the communication system 1. The present embodiment is not limited to the above example, and for example, one of the digital cameras 100-1 to 100-4 may be set to the sending mode, and the others may be set to the receiving mode. For example, in the present embodiment, each of the digital cameras 100-2 to 100-4 may be set to the sending mode as an example of the electronic device, and the digital camera 100-1 may be set to the receiving mode is an example of each of the plurality of imaging apparatuses.

For example, by the digital cameras 100 having transmission and reception functions and sharing the notification setting information T11, the extended setting information T12 (FIG. 4), and the sub-tag ID information T1 (FIG. 5), the setting for image shooting can be set in any one of the digital cameras 100 from the other digital cameras 100. In the present system 1, the digital camera 100 that has received the broadcast transmission data D1 and D2 can acquire a setting value in the setting for image shooting by referring to the information T1, T11, T12, and the like, even when the identifier of a transmission source and the like are unknown from the received data, for example. This also enables the plurality of digital cameras 100 to easily share and concurrently configure the setting for image shooting.

Further, for example, the digital camera 100-1 having the sending mode and the receiving mode may receive, as the shooting setting data, the transmission data broadcast from the control terminal 200, which is an example of an external electronic device, in the receiving mode. The digital camera 100-1 may change the setting for image shooting based on the received data.

As described above, in the present embodiment, the digital camera 100-1 as an example of the electronic device further includes the image sensor 115 as an example of an image sensor that performs image shooting. The communication module 155 further performs data communication with an external electronic device. The controller 135 receives the shooting setting data broadcast from the external electronic device in accordance with the BLE standard, which is as an example of the predetermined communication standard, with a communication connection being unestablished with the external electronic device via the communication module 155 according to the BLE standard, and changes the setting for image shooting by the image sensor 115 based on the received shooting setting data.

In the modification of the second embodiment described above, the example is described in which the preset icon 51 corresponding to the shooting direction for the subject 4 is provided as a composition option for the video shooting on the angle editing screen (FIG. 23B). In the present embodiment, the composition option may be set to a zoom magnification or an angle of view in video shooting for each of the digital cameras 100, for example. In the present embodiment, each of the digital cameras 100 may not necessarily be arranged such that shooting directions with respect to the subject 4 are different from each other.

In the second embodiment described above, the communication system 1A in which the control terminal 200 broadcasts the advertising data D21 and the like is described. The communication system 1A may include, the digital camera 100-1 similar to that in the communication system 1 illustrated in FIG. 1 instead of the control terminal 200, for example. In the communication system 1A according to the present embodiment, the digital camera 100-1 may perform processing similar to steps S11 to S15 in FIG. 19A to set the video creation setting in the digital cameras 100-2 to 100-4 and the audio device 50, for example.

In each of the above-described embodiments, the communication systems 1 and 1A that configure the setting for image shooting in the plurality of digital cameras 100 and the like by broadcasting before a connection is established according to the BLE standard are described. The predetermined communication standard in the communication system according to the present embodiment is not limited to the BLE standard, and other communication standards may be used. For example, broadcast communication and/or mesh routing according to ZigBee (registered trademark) may be used, and a broadcast function for Wi-Fi, Ethernet (registered trademark), or Bluetooth LE Audio may be used. In the present embodiment, multicasting or the like may be performed instead of the broadcast communication, and for example, the shooting setting data may be transmitted by multicasting.

In each of the above-described embodiments, the digital camera 100 including the optical system 110 is exemplified. Each of the imaging apparatuses according to the present embodiment may not include the optical system 110, and may be, for example, an interchangeable lens type camera.

In each of the above-described embodiments, the digital cameras are described as an example of the imaging apparatuses, but the embodiments are not limited thereto. Each of the imaging apparatuses according to the present disclosure may be an electronic device (e.g., a video camera, a smartphone, a tablet terminal, or the like) having an image capturing function.

### Aspect Examples

Hereinafter, various aspects of the present disclosure will be exemplified.

A first aspect according to the present disclosure is an electronic device capable of performing data communication with a plurality of imaging apparatuses. The electronic device including: a communication circuit that performs data communication with each of the plurality of imaging apparatuses; and a controller that generates shooting setting data indicating a setting for image shooting in the plurality of imaging apparatuses. The controller transmits the generated shooting setting data to the plurality of imaging apparatuses via broadcast communication in accordance with a predetermined communication standard to configure the setting for image shooting in the plurality of imaging apparatuses, with a communication connection being unestablished with each of the imaging apparatuses via the communication circuit according to the predetermined communication standard.

A second aspect is the electronic device according to the first aspect, further including an image sensor that performs image shooting, wherein the shooting setting data includes a setting value in the setting for image shooting, and the controller generates the shooting setting data based on the setting value set in the electronic device for image shooting by the image sensor.

A third aspect is the electronic device according to the first or second aspect, further including a user interface that receives a user operation, wherein the shooting setting data includes a setting value in the setting for image shooting, and the controller generates the shooting setting data based on a changed setting value by the user operation that changes the setting value via the user interface.

A fourth aspect is the electronic device according to any of the first to third aspects, wherein the setting for image shooting in the plurality of imaging apparatuses is configured for a plurality of states corresponding to a plurality of settings for an image to be shot in each of the imaging apparatuses, and the shooting setting data stores, for each state of the plurality of states, a setting value in the setting for image shooting.

A fifth aspect is the electronic device according to any of the first to fourth aspects, wherein the shooting setting data stores a setting value in the setting for image shooting for each of the imaging apparatuses in association with an identifier identifying the plurality of imaging apparatuses.

A sixth aspect is the electronic device according to the fifth aspect, wherein the plurality of imaging apparatuses includes a first imaging apparatus and a second imaging apparatus that are arranged with different directions from each other to shoot images of a subject by the respective imaging apparatuses, and the controller transmits, to the first and second imaging apparatuses via broadcast communication, the shooting setting data including the setting value associated with the identifier for each of the imaging apparatuses, to configure the setting for image shooting in each of the imaging apparatuses in accordance with the identifier.

A seventh aspect is the electronic device according to the sixth aspect, wherein the communication circuit further performs data communication with a sound reproduction device that outputs a sound based on sound source data, the first and second imaging apparatuses perform moving image shooting on the subject based on the shooting setting data, and the setting for image shooting includes a setting for a timing at which the sound indicated by the sound source data is output by the sound reproduction device in the moving image shooting.

An eighth aspect is the electronic device according to the seventh aspect, wherein the sound source data indicates a sound of music. The electronic device further includes a setting interface that sets, in management information for a moving image associated with the sound source data, a shooting unit for the moving image shooting by each of the first and second imaging apparatuses, the shooting unit being set in association with a period in the music. The management information is used to manage, for each shooting unit by each of the first and second imaging apparatuses, a timing of the moving image shooting according to the associated period in the music. The controller generates the shooting setting data based on the management information set by the setting interface.

A ninth aspect is the electronic device according to any of the first to eighth aspects, wherein the setting for image shooting in the plurality of imaging apparatuses includes at least one of a setting for an image to be captured by each of the imaging apparatuses and a setting for a timing of image shooting in each of the imaging apparatuses. The setting for the image to be captured includes at least one setting for sensitivity, an aperture value, a shutter speed, exposure correction, and white balance in image shooting.

A tenth aspect is the electronic device according to any of the first to ninth aspects, wherein the controller transmits, via broadcast communication, the shooting setting data by advertising in accordance with a Bluetooth Low Energy standard.

An eleventh aspect is the electronic device according to any of the first to tenth aspects, further including an image sensor that performs image shooting. The communication circuit further performs data communication with an external electronic device. The controller receives external shooting setting data transmitted from the external electronic device via broadcast communication in accordance with the communication standard and changes the setting for image shooting by the image sensor based on the received external shooting setting data, with a communication connection being unestablished with the external electronic device via the communication circuit according to the communication standard.

A twelfth aspect according to the present disclosure is a communication system including a plurality of imaging apparatuses; and an electronic device capable of performing data communication with the plurality of imaging apparatuses. The electronic device generates shooting setting data indicating a setting for image shooting in the plurality of imaging apparatuses, and transmits the generated shooting setting data to the plurality of imaging apparatuses via broadcast communication in accordance with a predetermined communication standard, with a communication connection unestablished with each of the imaging apparatuses according to the predetermined communication standard. Each of the plurality of imaging apparatuses receives the shooting setting data transmitted from the electronic device via the broadcast communication and changes the setting for image shooting based on the received shooting setting data.

A thirteenth aspect is the communication system according to the twelfth aspect, wherein the shooting setting data stores a setting value in the setting for image shooting, for each of the imaging apparatuses, in association with an identifier identifying the plurality of imaging apparatuses. The electronic device transmits, to the plurality of imaging apparatuses via broadcast communication, the shooting setting data generated by associating, for each of the imaging apparatuses, the setting value in image shooting with the identifier. Each of the plurality of imaging apparatuses acquires the setting value associated with each of the imaging apparatuses by the identifier from the received shooting setting data, and applies the acquired setting value to the setting for image shooting.

A fourteenth aspect is a tangible non-transitory computer readable medium storing a program executed by a controller of a computer to cause the computer to function as the electronic device according to any of the first to eleventh aspects.

As described above, the above-described embodiments are described as examples of techniques in the present disclosure. To this extent, the attached drawings and detailed descriptions are provided.

Therefore, components described in the attached drawings and the detailed description include not only components indispensable to solve the problem, but may also include components not necessarily indispensable to solve the problem in order to provide examples of the techniques. Therefore, those components not necessarily indispensable should not be deemed essential due to the mere fact that those components not necessarily indispensable are described in the attached drawings and the detailed description.

Further, since the above-described embodiments are given as the examples of the techniques according to the present disclosure, various modifications, replacements, additions, omissions, or the like can be made within the scope of the claims or in a scope equivalent to the scope of the claims.

The present disclosure is applicable to an electronic device capable of performing data communication with a plurality of imaging apparatuses, and to a communication system.

1. An electronic device capable of performing data communication with a plurality of imaging apparatuses, the electronic device comprising:
a communication circuit that performs data communication with each of the plurality of imaging apparatuses; and
a controller that generates shooting setting data indicating a setting for image shooting in the plurality of imaging apparatuses,
wherein the controller transmits the generated shooting setting data to the plurality of imaging apparatuses via broadcast communication in accordance with a predetermined communication standard to configure the setting for image shooting in the plurality of imaging apparatuses, with a communication connection being unestablished with each of the imaging apparatuses via the communication circuit according to the predetermined communication standard.

2. The electronic device according to claim 1, further comprising an image sensor that performs image shooting,
wherein the shooting setting data includes a setting value in the setting for image shooting, and
the controller generates the shooting setting data based on the setting value set in the electronic device for image shooting by the image sensor.

3. The electronic device according to claim 1, further comprising a user interface that receives a user operation,
wherein the shooting setting data includes a setting value in the setting for image shooting, and
the controller generates the shooting setting data based on a changed setting value by the user operation that changes the setting value via the user interface.

4. The electronic device according to claim 1, wherein
the setting for image shooting in the plurality of imaging apparatuses is configured for a plurality of states corresponding to a plurality of settings for an image to be shot in each of the imaging apparatuses, and
the shooting setting data stores, for each state of the plurality of states, a setting value in the setting for image shooting.

5. The electronic device according to claim 1, wherein
the shooting setting data stores a setting value in the setting for image shooting for each of the imaging apparatuses in association with an identifier identifying the plurality of imaging apparatuses.

6. The electronic device according to claim 5, wherein
the plurality of imaging apparatuses includes a first imaging apparatus and a second imaging apparatus that are arranged with different directions from each other to shoot images of a subject by the respective imaging apparatuses, and
the controller transmits, to the first and second imaging apparatuses via broadcast communication, the shooting setting data including the setting value associated with the identifier for each of the imaging apparatuses, to configure the setting for image shooting in each of the imaging apparatuses in accordance with the identifier.

7. The electronic device according to claim 6, wherein
the communication circuit further performs data communication with a sound reproduction device that outputs a sound based on sound source data,
the first and second imaging apparatuses perform moving image shooting on the subject based on the shooting setting data, and
the setting for image shooting includes a setting for a timing at which the sound indicated by the sound source data is output by the sound reproduction device in the moving image shooting.

8. The electronic device according to claim 7, wherein
the sound source data indicates a sound of music,
the electronic device further comprises a setting interface that sets, in management information for a moving image associated with the sound source data, a shooting unit for the moving image shooting by each of the first and second imaging apparatuses, the shooting unit being set in association with a period in the music,
the management information is used to manage, for each shooting unit by each of the first and second imaging apparatuses, a timing of the moving image shooting according to the associated period in the music, and
the controller generates the shooting setting data based on the management information set by the setting interface.

9. The electronic device according to claim 1, wherein
the setting for image shooting in the plurality of imaging apparatuses includes at least one of a setting for an image to be captured by each of the imaging apparatuses or a setting for a timing of image shooting in each of the imaging apparatuses, and
the setting for the image to be captured includes at least one setting for sensitivity, an aperture value, a shutter speed, exposure correction, or white balance in image shooting.

10. The electronic device according to claim 1, wherein
the controller transmits, via broadcast communication, the shooting setting data by advertising in accordance with a BLUETOOTH Low Energy standard.

11. The electronic device according to claim 1, further comprising an image sensor that performs image shooting,
wherein the communication circuit further performs data communication with an external electronic device, and
the controller receives external shooting setting data transmitted from the external electronic device via broadcast communication in accordance with the communication standard and changes the setting for image shooting by the image sensor based on the received external shooting setting data, with a communication connection being unestablished with the external electronic device via the communication circuit according to the communication standard.

12. A communication system comprising:
a plurality of imaging apparatuses; and
an electronic device capable of performing data communication with the plurality of imaging apparatuses,
wherein the electronic device
generates shooting setting data indicating a setting for image shooting in the plurality of imaging apparatuses, and
transmits the generated shooting setting data to the plurality of imaging apparatuses via broadcast communication in accordance with a predetermined communication standard, with a communication connection unestablished with each of the imaging apparatuses according to the predetermined communication standard, and
each of the plurality of imaging apparatuses receives the shooting setting data transmitted from the electronic device via the broadcast communication and changes the setting for image shooting based on the received shooting setting data.

13. The communication system according to claim 12, wherein
the shooting setting data stores a setting value in the setting for image shooting, for each of the imaging apparatuses, in association with an identifier identifying the plurality of imaging apparatuses, and
the electronic device transmits, to the plurality of imaging apparatuses via broadcast communication, the shooting setting data generated by associating, for each of the imaging apparatuses, the setting value in image shooting with the identifier, and
each of the plurality of imaging apparatuses acquires the setting value associated with each of the imaging apparatuses by the identifier from the received shooting setting data, and applies the acquired setting value to the setting for image shooting.

14. A tangible non-transitory computer readable medium storing a program that is executed by a controller of a computer to cause the computer to function as the electronic device according to claim 1.
